(19) United States
(12) Patent Application Publication
(10) Pub. No.: US 2012/0082230 A1
(43) Pub. Date: Apr. 5, 2012

(54) VARIABLE LENGTH CODING OF VIDEO BLOCK COEFFICIENTS

(75) Inventors: Marta Karczewicz, San Diego, CA (US); Xianglin Wang, San Diego, CA (US); Wei-Jung Chien, San Diego, CA (US)

(73) Assignee: QUALCOMM Incorporated, San Diego, CA (US)

(21) Appl. No.: 13/218,206

(22) Filed: Aug. 25, 2011

Related U.S. Application Data
(60) Provisional application No. 61/389,178, filed on Oct. 1, 2010.

(51) Int. Cl. H04N 7/30; H04N 7/26

(52) U.S. Cl. 375/240.18; 375/E07.144; 375/E07.226

(57) ABSTRACT

This disclosure describes techniques for coding transform coefficients for a block of video data. According to one aspect of this disclosure, a coder (e.g., an encoder or decoder) may map between a code number cn and a level_ID value and an run value based on a structured mapping. According to other aspects of this disclosure, the coder may map between a code number cn and a level_ID value and an run value for the current transform coefficient using a first technique or a second technique based on a coded block type of a block of video data being coded. For example, if the coded block type is a first coded block type, the coder may use a structured mapping. However, if the coded block type is a second coded block type different than the first coded block type, the coder may access one or more mapping tables stored in memory to perform the mapping.

This application claims the benefit of U.S. Provisional Application No. 61/389,178 titled “VLC COEFFICIENT CODING” filed Oct. 1, 2010, the entire contents of which are incorporated herein by reference.

### TECHNICAL FIELD

This disclosure relates to video coding and compression. More specifically, this disclosure is directed to techniques for coding quantized transform coefficients using variable length coding (VLC).

### BACKGROUND

Quantized transform coefficients, as well as motion vectors describing relative motion between a block to be encoded and a reference block, may be referred to as “syntax elements.” Syntax elements, along with other control information, may form a coded representation of the video sequence. In some examples, prior to transmission from an encoder to a decoder, syntax elements may be entropy coded, thereby further reducing a number of bits needed for their representation. Entropy coding may be described as a lossless operation aimed at minimizing a number of bits required to represent transmitted or stored symbols (e.g., syntax elements) by utilizing properties of their distribution (e.g., some symbols occur more frequently than others).

One method of entropy coding employed by video coders is Variable Length Coding (VLC). According to VLC, a VLC codeword (a sequence of bits (0's and 1's)), may be assigned to each symbol (e.g., syntax element). VLC codewords may be constructed such that a length of the codeword corresponds to how frequently the symbol represented by the codeword occurs. For example, more frequently occurring symbols may be represented by shorter VLC codewords. In addition, VLC codewords may be constructed such that the codewords are uniquely decodable. For example if a decoder receives a valid sequence of bits of a finite length, there may be only one possible sequence of input symbols that, when encoded, would produce the received sequence of bits.

### SUMMARY

This disclosure is directed to coding transform coefficients of a block of video data using variable length code (VLC) techniques of this disclosure. According to one aspect of this disclosure, techniques are provided for using a structured mapping (e.g., a mathematical relationship) to map between run and level_ID values to a code number cn. Such a structured mapping may be based on a most likely run value from a current coefficient to a next non-zero coefficient of the block of video data with a magnitude greater than one. In some examples, such a structured mapping may not use any mapping tables stored in memory that define a relationship between the run and level_ID values and the code number cn. Instead, in some example, such a structured mapping may be based on at least one value stored in memory. The at least one value may indicate the most likely run value from the current coefficient to the next non-zero coefficient of the block of video data with a magnitude greater than one.

In some examples, the at least one value stored in memory may be determined based on a noTr1 value. In some examples, the noTr1 value may indicate whether or not any previously coded coefficient of the block of video data has a magnitude greater than one. In other examples, the noTr1 value may instead indicate a number of previously coded coefficients of the block with a magnitude equal to one.

According to another aspect of this disclosure, techniques are provided for mapping between run and level_ID to a code number cn using either of a first technique or a second technique, based on a coded block type of a block of video data. For example, according to these techniques a coder may use the first technique if the block of video data has a first coded block type, and use the second technique if the block of video data has a second coded block type different than the first coded block type. In some examples, the first technique may comprise a structured mapping as described above. The second technique may comprise accessing at least one mapping table of a plurality of mapping tables stored in memory that define a relationship between the run and level_ID values and the code number cn. In some examples, a coder may use the first technique if a coded block type of a block of video is intra-coded luma. Otherwise (e.g., if the coded block type of the block of video data is an inter-coded luma or chroma, or an intra-coded chroma), the coder may use the second technique.

According to one example, a method of decoding a block of video data is described herein. The method includes determining a code number cn based on a VLC codeword. The method further includes determining a level_ID value and a run value associated with a transform coefficient of the block of video data using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The method further includes using at least one of the determined level_ID value and the determined run value to decode the block of video data.

According to another example, a device for decoding a block of video data is described herein. The device includes a VLC decoding module configured to determine a code number cn based on a VLC codeword. The VLC decoding module is further configured to determine a level_ID value and a run value associated with a transform coefficient of the block of video data using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The VLC decoding module is further configured to use at least one of the determined level_ID value and the determined run value to decode the block of video data.

According to another example, a device for decoding a block of video data is described herein. The device includes means for determining a code number cn based on a VLC codeword. The device further includes means for determining a level_ID value and a run value associated with a transform coefficient of the block of video data using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The device further includes means for using at least one of the determined level_ID value and the determined run value to decode the block of video data.

According to another example, a computer-readable storage medium that stores instructions is described herein. The instructions are configured to cause a computing device to determine a code number cn based on a VLC codeword. The instructions further cause the computing device to determine a level_ID value and a run value associated with a transform coefficient of the block of video data using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The instructions further cause the computing device to use at least one of the determined level_ID value and the determined run value to decode the block of video data.

According to another example, a method of encoding a block of video data is described herein. The method includes determining a level_ID value and a run value associated with a transform coefficient of the block of video dat. The method further includes determining a code number cn based on the determined level_ID value and the determined run value using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The method further includes determining a VLC codeword based on the determined code number cn. The method further includes outputting the determined VLC codeword.

According to another example, a device for encoding a block of video data is described herein. The device includes a VLC encoding module. The VLC encoding module is configured to determine a level_ID value and a run value associated with a transform coefficient of the block of video data. The VLC encoding module is further configured to determine a code number cn based on the determined level_ID value and the determined run value using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The VLC encoding module is further configured to determine a VLC codeword based on the determined code number cn. The VLC encoding module is further configured to output the determined VLC codeword.

According to another example, a device for encoding a block of video data is described herein. The device includes means for determining a level_ID value and a run value associated with a transform coefficient of the block of video data. The device further includes means for determining a code number cn based on the determined level_ID value and the determined run value using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The device further includes means for determining a VLC codeword based on the determined code number cn. The device further includes means for outputting the determined VLC codeword.

According to another example, a computer-readable storage medium that stores instructions is described herein. The instructions are configured to cause a computing device to determine a level_ID value and a run value associated with a transform coefficient of the block of video data. The instructions are further configured to cause the computing device to determine a code number cn based on the determined level_ID value and the determined run value using a structured mapping that defines a relationship between the code number cn and the level_ID value and the run value. The level_ID value indicates, with respect to a position of a current transform coefficient, whether a next non-zero transform coefficient of a block of video data has a magnitude of one or greater than one, and the run value indicates a number of zero value transform coefficients of the block, from the current transform coefficient to the next non-zero transform coefficient of the block of video data. The instructions are further configured to cause the computing device to determine a VLC codeword based on the determined code number cn. The instructions are further configured to cause the computing device to output the determined VLC codeword.

According to another example, a method of decoding a current transform coefficient of a block of video data is described herein. The method includes determining a coded block type of a block of video data that includes at least one transform coefficient. The method further includes determining a code number cn based on a VLC codeword. The method further includes, if the block of video data has a first coded block type, determining a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The method further includes, if the block has a second coded block type different than the first coded block type, determining the level_ID value and the run value associated with the transform coefficient using a second technique different than the first technique. The method further includes using the determined level_ID value and the determined run value to decode the block of video data.

According to another example, a device configured to decode a block of video data is described herein. The device includes a VLC decoding module configured to determine a coded block type of a block of video data that includes at least one transform coefficient. The VLC decoding module is further configured to determine a code number cn based on a VLC codeword. The VLC decoding module is further configured to, if the block of video data has a first coded block type, determine a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The VLC decoding module is further configured to, if the block has a second coded block type different than the first coded block type, determining the level_ID value and the run value associated with the transform coefficient using a second technique different than the first technique. The VLC decoding module is further configured to use the determined level_ID value and the determined run value to decode the block of video data.

According to another example, a device configured to decode a block of video data is described herein. The device includes means for determining a coded block type of a block of video data that includes at least one transform coefficient. The device further includes means for determining a code number cn based on a VLC codeword. The device further includes means for, if the block of video data has a first coded block type, determining a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The device further includes means for, if the block has a second coded block type different than the first coded block type, determining the level_ID value and the run value associated with the transform coefficient using a second technique different than the first technique. The device further includes means for using the determined level_ID value and the determined run value to decode the block of video data.

According to another example, a computer-readable storage medium comprising instructions is described herein. The instructions are configured to cause a computing device to determine a coded block type of a block of video data that includes at least one transform coefficient. The instructions are further configured to cause the computing device to determine a code number cn based on a VLC codeword. The instructions are further configured to cause the computing device to, if the block of video data has a first coded block type, determine a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The instructions are further configured to cause the computing device to, if the block has a second coded block type different than the first coded block type, determine the level_ID value and the run value associated with the transform coefficient using a second technique different than the first technique. The instructions are further configured to cause the computing device to use the determined level_ID value and the determined run value to decode the block of video data.

According to another example, a method of encoding a current transform coefficient of a block of video data. The method includes determining a coded block type of a block of video data that includes at least one transform coefficient. The method further includes determining a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The method further includes, if the block of video data has a first coded block type, determining a code number cn based on the determined level_ID value and the determined run value using a first technique. The method further includes, if the block has a second coded block typedifferent than the first coded block type, determining the code number cn based on the determined level_ID value and the determined run value using a second technique different than the first technique. The method further includes determining a VLC codeword based on the determined code number cn. The method further includes outputting the determined VLC codeword.

According to another example, a device configured to encode a block of video data is described herein. The device includes a VLC encoding module configured to determine a coded block type of a block of video data that includes at least one transform coefficient. The VLC encoding module is further configured to determine a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, the run value indicates a number of zero value transform coefficients of the block, from the current transform coefficient to the next non-zero transform coefficient of the block of video data, and the code number cn comprises an codeword index value for a VLC table selected from one or more VLC tables. The VLC encoding module is further configured to, if the block of video data has a first coded block type, determine a code number cn based on the determined level_ID value and the determined run value using a first technique. The VLC encoding module is further configured to if the block has a second coded block type different than the first coded block type, determine the code number cn based on the determined level_ID value and the determined run value using a second technique different than the first technique. The VLC encoding module is further configured to determine a VLC codeword based on the determined code number cn. The VLC encoding module is further configured to output the determined VLC codeword.

According to another example, a device configured to encode a block of video data is described herein. The device includes means for determining a coded block type of a block of video data that includes at least one transform coefficient. The device further includes means for determining a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, and the run value indicates a number of zero value transform coefficients of the block, from the current transform coefficient to the next non-zero transform coefficient of the block of video data, and wherein the code number cn comprises an codeword index value for a VLC table selected from one or more VLC tables. The device further includes means for, if the block of video data has a first coded block type, determining a code number cn based on the determined level_ID value and the determined run value using a first technique. The device further includes means for, if the block has a second coded block type different than the first coded block type, determining the code number cn based on the determined level_ID value and the determined run value using a second technique different than the first technique. The device further includes means for determining a VLC codeword based on the determined code number cn. The device further includes means for outputting the determined VLC codeword.

According to another example, a computer-readable storage medium that stores instructions is described herein. The instructions are configured to cause a computing device to determine a coded block type of a block of video data that includes at least one transform coefficient. The instructions are further configured to cause the computing device to determine a level_ID value and a run value associated with the at least one transform coefficient using a first technique. The level_ID value indicates, with respect to a position of a current transform coefficient of the block of video data, whether a next non-zero transform coefficient of the block of video data has a magnitude of one or greater than one, the run value indicates a number of zero value transform coefficients of the block, from the current transform coefficient to the next non-zero transform coefficient of the block of video data, and the code number cn comprises an codeword index value for a VLC table selected from one or more VLC tables. The instructions are further configured to cause the computing device to, if the block of video data has a first coded block type, determine a code number cn based on the determined level_ID value and the determined run value using a first technique. The instructions are further configured to cause the computing device to, if the block has a second coded block type different than the first coded block type, determine the code number cn based on the determined level_ID value and the determined run value using a second technique different than the first technique. The instructions are further configured to cause the computing device to determine a VLC codeword based on the determined code number cn. The instructions are further configured to cause the computing device to output the determined VLC codeword.

The details of one or more examples are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram that illustrates one example of a video encoding and decoding system consistent with the techniques of this disclosure.

FIG. 2 is a block diagram that illustrates one example of a video encoder consistent with the techniques of this disclosure.

FIG. 3 is a block diagram that illustrates one example of a video decoder consistent with the techniques of this disclosure.

FIG. 4 is a conceptual diagram that illustrates one example of an inverse zig-zag scan of transform coefficients of a video block consistent with the techniques of this disclosure.

FIG. 5 is a conceptual diagram that illustrates one example of a technique for encoding a transform coefficient consistent with the techniques of this disclosure.

FIG. 6 is a conceptual diagram that illustrates one example of a technique for decoding a transform coefficient consistent with the techniques of this disclosure.

FIG. 7 is a flow diagram that illustrates one example of a method of coding a block of video data consistent with the techniques of this disclosure.

FIG. 8 is a flow diagram that illustrates one example of a method of coding a block of video data consistent with the techniques of this disclosure.

### DETAILED DESCRIPTION

This disclosure describes video coding techniques for coding (e.g., encoding, decoding) syntax elements (e.g., quantized transform coefficients) of a block of video data using one or more variable length code (VLC) codewords of a VLC table. According to these techniques, an encoder may determine values associated with the transform coefficient, map the determined values to a code number cn, and use the code number cn to access a VLC table. Based on the determined code number cn, the encoder may output a VLC code word that represents the determined values.

The mapping of VLC codewords of a VLC table to symbols represented by the codewords may be constructed such that a length of the codeword corresponds to how frequently the symbol represented by the codeword occurs. For example, more frequently occurring symbols may be represented by shorter VLC codewords. In addition, VLC codewords may be constructed such that the codewords are uniquely decodable. For example if a decoder receives a valid sequence of bits of a finite length, there may be only one possible sequence of input symbols that, when encoded, would produce the received sequence of bits.

A decoder may receive a VLC codeword from an encoder. The decoder may access a VLC table (e.g., the same VLC table as encoder described above), and determine a code number for the VLC codeword. The decoder may map the determined code number cn to one or more values associated with the transform coefficient of video data. By using VLC codewords to signal, from an encoder to a decoder, one or more values associated with transform coefficients of a block of video data, an amount of data used to code (e.g., encode or decode) a block of video data may be reduced.

In some examples, coefficients of a given block of a video frame may be ordered (scanned) according to a zigzag scanning technique. Such a technique may be used to generate a one-dimensional ordered coefficient vector. A zig-zag scanning begins at an upper leftmost coefficient of a block, and proceeding to scan in a zig-zag pattern to a lower rightmost coefficient of the block.

According to a zigzag scanning technique, it may be presumed that transform coefficients having a greatest energy (e.g., a greatest coefficient value) correspond to low frequency transform functions and may be located towards a top-left corner of a block. As such, for a coefficient vector (e.g., one-dimensional coefficient vector) produced based on zigzag scanning, higher magnitude coefficients may be assumed to most likely appear towards a start of the one-dimensional coefficient vector. It may also be assumed that, after a coefficient vector has been quantized, most low energy coefficients may be equal to 0. In some examples, coefficient scanning order may be adapted during coefficient coding. For example a lower number in the scan may be assigned to positions for which non-zero coefficients happen more often. Although many of the techniques of this disclosure will be described from the perspective of zig-zag scans (or inverse zig-zag scans), other scans (e.g., horizontal scans, vertical scans, combinations of horizontal, vertical and/or zig-zag scans, adaptive scans or other scans) could also be used.

According to one example, a coder may perform an inverse zig-zag scan. According to an inverse zig-zag scan, the coder may begin coding at a location that corresponds to a last non-zero coefficient (e.g., a non-zero coefficient furthest from an upper left position of the block). The encoder may code in a zig-zag pattern as described above, but beginning in a bottom right position of the block and ending in an upper left position of the block.

According to some examples, a coder may be configured to operate in multiple different coding modes when performing a scan of transform coefficients. According to one such example, a coder may switch between a run coding mode and a level mode of coding based on magnitudes of one or more already coded coefficients.

According to a level coding mode, an encoder may signal a magnitude (|level|) of each coefficient. The encoder may signal the magnitude (|level|) using a VLC table of a plurality of VLC tables (e.g., a table VLC[x], where x is zero for a first coefficient that is being coded in the level mode). According to a level coding mode, after decoding each coefficient, if |level| of the syntax element has a magnitude greater than a predetermined value (e.g., vlc_level_table[x]), then the value x may be incremented by one.

According to a run coding mode, a coder may signal a level_ID syntax element and a run syntax element based on a current coefficient position according to a scan order. The current coefficient may be described as the first coefficient of a run according to a scan order. The level_ID syntax element may indicate, starting from a current coefficient position, whether a next non-zero coefficient of the scan (e.g., a next coefficient in an inverse-scan order) has a magnitude of one or greater than one. The run syntax element may indicate a number of quantized coefficients with a magnitude equal to zero between a current (currently coded) coefficient and a next non-zero coefficient in the scan order (e.g., an inverse zig-zag scan order). According to one example, run may have a value in a range from zero to k+1, wherein k is a position index value of the current coefficient in a scan. According to a run coding mode, an encoder may determine values for run and level_ID, and signal the values for run and level_ID as a VLC codeword. In some examples, the level_ID and run syntax elements described above may be concatenated into a single syntax element and coded as a single VLC codeword. According to one example, such a concatenated level_ID and run syntax element may be referred to as “is_level_one_RUN.”

To determine a VLC codeword as described above, an encoder may access a mapping table of a plurality of mapping tables that defines a mapping from the values run and level_ID to different values of code number cn. Such a mapping table may be selected by an encoder based on a position index value k of a current coefficient in the scan order. For example, a first such mapping table may be used for a position k equal to zero, and a second, different mapping table may be used for a position k equal to one. Position k may be described to as a number of coefficients between a current coefficient and a last coefficient in an inverse scan order. Such a last coefficient may comprise a last coefficient in inverse zig-zag scan order. Again, although the techniques are described according to zig-zag and inverse zig-zag scans, similar techniques could apply to any scan order.

The code number cn may represent an index within a VLC table in a plurality of VLC tables. The encoder may select a VLC table from among a plurality of VLC tables based on a position of a current coefficient in scan order. Based on the code number cn, the encoder may determine a VLC codeword using the selected VLC table. The encoder may signal such a determined VLC codeword to a decoder. The decoder may decode a code number cn based on the received VLC codeword, and then use the code number cn to determine the values run and level_ID based on a current coefficient position. The decoder may use the determined values of run and level_ID to decode coefficients between a current coefficient and a next non-zero coefficient in scan order.

In some examples, storing a plurality of mapping tables may be undesirable where an amount of memory available to the coder is limited. As such, it may be desirable to reduce a number of mapping tables stored in memory that are used to map between a code number cn and level_ID and run values.

According to one aspect of this disclosure, a coder may map values for run and level_ID to a code number cn based on a structured mapping (e.g., a mathematical relationship) as opposed to using a mapping table of a plurality of mapping tables as described. By using such a structured mapping, a number of mapping tables stored in a memory of the coder may be reduced. Accordingly, memory that may have been used to store such a plurality of mapping tables may be allocated to other purposes, and thereby improve a coding efficiency of the coder.

In some examples, such a structured mapping may be based on a position k of a transform coefficient. In other examples, such a structured mapping may also or instead be based on a most likely run value from a current coefficient to a next non-zero coefficient of the block of video data with a magnitude greater than one.

In some example, such a structured mapping may be based on at least one value stored in memory (e.g., an lrg1Pos value). The at least one value stored in memory may indicate the most likely run value from a current coefficient to a next non-zero coefficient of the block of video data with a magnitude greater than one. In some examples, the at least one value stored in memory may be determined based on a noTr1 value. The noTr1 value may indicate whether or not any previously coded coefficient of the block of video data has a magnitude greater than one. The noTr1 value may instead indicate a number of previously coded coefficients of the block with a magnitude equal to one. In some examples, the at least one value stored in memory may be determined based on at least one table stored in memory that defines a relationship between the at least one value stored in memory and one or more of a position k of a current transform coefficient and the noTr1 value. According to such examples, the one or more tables stored in memory that define the relationship between one or more of the at least one value and one or more of the position k and the noTr1 value and the at least one value stored in memory may consume less memory than the plurality of mapping tables described above.

According to another aspect of this disclosure, techniques are provided for mapping between run and level_ID to a code number cn using either of a first technique or a second technique based on a coded block type of a block of video data. In some examples, the first technique may comprise a structured mapping as described above. In some examples, the second technique may comprise accessing at least one mapping table stored in memory that defines the relationship between the run and level_ID values and the code number cn. In some examples, a coder may use the first technique if a coded block type of a block of video is intra-coded luma. Otherwise (e.g., if the coded block type of the block of video data is inter-coded luma or chroma, or intra-coded chroma), the coder may use the second technique.

According to the techniques described herein, a coder (e.g., encoder, decoder) may reduce a number of mapping tables stored in memory that define the mapping between run, level_ID, and code number cn. These techniques may thereby improve an efficiency of the coder.

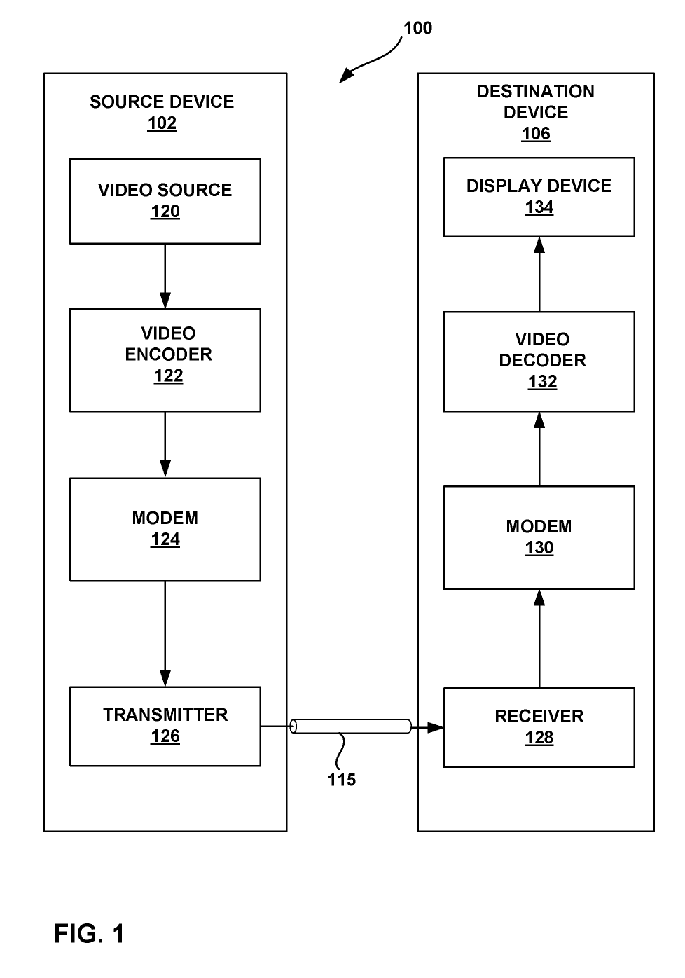

FIG. 1 is a block diagram illustrating an exemplary video encoding and decoding system 100 that may implement techniques of this disclosure. As shown in FIG. 1, system 100 includes a source device 102 that transmits encoded video to a destination device 106 via a communication channel 115. Source device 102 and destination device 106 may comprise any of a wide range of devices. In some cases, source device 102 and destination device 106 may comprise wireless communication device handsets, such as so-called cellular or satellite radiotelephones. The techniques of this disclosure, however, which apply generally to the encoding and decoding transform coefficients of video data, are not necessarily limited to wireless applications or settings, and may be applied to a wide variety of non-wireless devices that include video encoding and/or decoding capabilities.

In the example of FIG. 1, source device 102 may include a video source 120, a video encoder 122, a modulator/demodulator (modem) 124 and a transmitter 126. Destination device 106 may include a receiver 128, a modem 130, a video decoder 132, and a display device 134. In accordance with this disclosure, video encoder 122 of source device 102 may be configured to encode run and level_ID values based on determining a code number cn. For example, video encoder may use the determined code number cn to determine a VLC codeword that represents the run and level_ID values. In some examples, video encoder 122 may determine the code number cn based accessing a mapping table of a plurality of mapping tables stored in a memory accessible by video encoder 122.

In other examples, according to the techniques described herein, video encoder 122 may not determine the code number cn based on such a mapping table. Instead, according aspect of this disclosure, video encoder 122 may determine the code number cn based on a structured mapping as described above.

According to other aspects of this disclosure, video encoder 122 may use either a first technique (e.g., structured mapping as described above) or a second technique (e.g., table based mapping) to determine the code number cn based on a coded block type of a block of video data being encoded. For example, if the coded block type is intra-coded luma, video encoder 122 may determine the code number cn based on the first technique (e.g., a structured mapping as described above). Otherwise, video encoder 122 may determine the code number cn based on a second technique (e.g., accessing mapping table of a plurality of mapping tables stored in a memory associated with video encoder 122).

Blocks of video data generally comprise residual blocks of transform coefficients. The transform coefficients may be produced by transforming residual pixel values indicative of differences between a predictive block and the original block being coded. The transform may be an integer transform, a DCT transform, a DCT-like transform that is conceptually similar to DCT, or the like. Transforms may be implemented according to a so-called butterfly structure for transforms, or may be implemented as matrix multiplications.

Reciprocal transform coefficient decoding may also be performed by video decoder 132 of destination device 106. That is, video decoder 132 may be configured to receive a VLC codeword for transform coefficients, determine a code number cn for the VLC codeword, and determine the run and level_ID values based on the determined code number cn. For example, according to one aspect of this disclosure, video decoder 132 may determine the level_ID and run values based on a structured mapping as described above, instead of using a mapping table of a plurality of mapping tables.

According to another aspect of this disclosure, video decoder 132 may use a first technique or a second technique to determine the level_ID and run values based on a coded block type of a block of video data being decoded. For example, if the coded block type of the block of video data is intra-coded luma, video decoder 132 may use the first technique (e.g., a structured mapping as described above) to determine the level_ID and run values. Otherwise, video decoder 132 may use a second technique (e.g., a mapping table of a plurality of mapping tables) to determine the level_ID and run values.

The illustrated system 100 of FIG. 1 is merely exemplary. The transform coefficient encoding and decoding techniques of this disclosure may be performed by any encoding or decoding devices. Source device 102 and destination device 106 are merely examples of coding devices that can support such techniques.

Video encoder 122 of source device 102 may encode video data received from video source 120. Video source 120 may comprise a video capture device, such as a video camera, a video archive containing previously captured video, or a video feed from a video content provider. As a further alternative, video source 120 may generate computer graphics-based data as the source video, or a combination of live video, archived video, and computer-generated video. In some cases, if video source 120 is a video camera, source device 102 and destination device 106 may form so-called camera phones or video phones. In each case, the captured, pre-captured or computer-generated video may be encoded by video encoder 122.

In system 100, once the video data is encoded by video encoder 122, the encoded video information may then be modulated by modem 124 according to a communication standard, e.g., such as code division multiple access (CDMA) or any other communication standard or technique, and transmitted to destination device 106 via transmitter 126. Modem 124 may include various mixers, filters, amplifiers or other components designed for signal modulation. Transmitter 126 may include circuits designed for transmitting data, including amplifiers, filters, and one or more antennas. Receiver 128 of destination device 106 receives information over channel 115, and modem 130 demodulates the information. Again, the video decoding process performed by video decoder 132 may include similar (e.g., reciprocal) transform coefficient decoding techniques to the transform coefficient encoding techniques performed by video encoder 122.

Communication channel 115 may comprise any wireless or wired communication medium, such as a radio frequency (RF) spectrum or one or more physical transmission lines, or any combination of wireless and wired media. Communication channel 115 may form part of a packet-based network, such as a local area network, a wide-area network, or a global network such as the Internet. Communication channel 115 generally represents any suitable communication medium, or a collection of different communication media, for transmitting video data from source device 102 to destination device 106.

Although not shown in FIG. 1, in some aspects, video encoder 122 and video decoder 132 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 122 and video decoder 132 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 122 and video decoder 132 may be included in one or more encoders or decoders, either of which may be integrated as part of a combined encoder/decoder (CODEC) in a respective mobile device, subscriber device, broadcast device, server, or the like.

In some cases, devices 102, 106 may operate in a substantially symmetrical manner. For example, each of devices 102, 106 may include video encoding and decoding components. Hence, system 100 may support one-way or two-way video transmission between video devices 102, 106, e.g., for video streaming, video playback, video broadcasting, or video telephony.

During the encoding process, video encoder 122 may execute a number of coding techniques or operations. In general, video encoder 122 operates on video blocks within individual video frames (or other independently coded units such as slices) in order to encode the video blocks. Frames, slices, portions of frames, groups of pictures, or other data structures may be defined as independent data units that include a plurality of video blocks, and syntax elements may be included at such different independent data units. The video blocks within independent data units may have fixed or varying sizes, and may differ in size according to a specified coding standard. In some cases, each video frame may include a series of independently decodable slices, and each slice may include one or more macroblocks or LCUs.

Macroblocks are one type of video block defined by the ITU H.264 standard and other standards. Macroblocks typically refer to 16 by 16 blocks of data. The ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components.

The emerging HEVC standard defines new terms for video blocks. In particular, with HEVC, video blocks (or partitions thereof) may be referred to as “coded units.” With the HEVC standard, largest coded units (LCUs) may be divided into smaller and smaller coded units (CUs) according to a quadtree partitioning scheme, and the different CUs that are defined in the scheme may be further partitioned into so-called prediction units (PUs) and/or transform units (TUs). The LCUs, CUs, and PUs, and TUs are all video blocks within the meaning of this disclosure. Other types of video blocks may also be used, consistent with the HEVC standard or other video coding standards. Thus, the phrase “block” refers to any size of video block. Moreover, video blocks may sometimes refer to blocks of video data in the pixel domain, or blocks of data in a transform domain such as a discrete cosine transform (DCT) domain, a domain similar to DCT, a wavelet domain, or the like.

Referring again to FIG. 1, video encoder 122 may perform predictive coding in which a video block being coded is compared to another block of video data in order to identify a predictive block. This process of predictive coding is often referred to as motion estimation and motion compensation. Motion estimation estimates video block motion relative to one or more predictive video blocks of one or more predictive frames (or other coded units). Motion compensation generates the desired predictive video block from the one or more predictive frames or other coded units. Motion compensation may include an interpolation process in which interpolation filtering is performed to generate predictive data at fractional pixel precision.

After generating the predictive block, the differences between the current video block being coded and the predictive block are coded as a residual block, and prediction syntax (such as a motion vector) is used to identify the predictive block. The residual block may be transformed and quantized. Transform techniques may comprise a DCT process or conceptually similar process, integer transforms, wavelet transforms, or other types of transforms. In a DCT or DCT-like process, as an example, the transform process converts a set of pixel values (e.g., residual values) into transform coefficients, which may represent the energy of the pixel values in the frequency domain. Quantization is typically applied on the transform coefficients, and generally involves a process that limits the number of bits associated with any given transform coefficient.

Following transform and quantization, entropy coding may be performed on the transformed and quantized residual video blocks. Syntax elements, (e.g., the run and level_ID values described herein), various filter syntax information, and prediction vectors defined during the encoding may be included in the entropy-coded bitstream. In general, entropy coding comprises one or more processes that collectively compress a sequence of quantized transform coefficients and/or other syntax information. Scanning techniques, such as zig-zag scanning (and/or inverse zig-zag scanning) techniques, are performed on the quantized transform coefficients in order to define one or more serialized one-dimensional vectors of coefficients from two-dimensional video blocks. Again, other scan orders, including fixed or adaptive scan orders, could also be used consistent with this disclosure. The scanned coefficients are then entropy coded along with any syntax information, e.g., via content adaptive variable length coding (CAVLC), context adaptive binary arithmetic coding (CABAC), or another entropy coding process.

As part of the encoding process, encoded video blocks may be decoded to generate the video data used for subsequent prediction-based coding of subsequent video blocks. At this stage, filtering may be employed in order to improve video quality, and e.g., remove blockiness or other artifacts from decoded video. This filtering may be in-loop or post-loop. With in-loop filtering, the filtering of reconstructed video data occurs in the coding loop, which means that the filtered data is stored by an encoder or a decoder for subsequent use in the prediction of subsequent image data. In contrast, with post-loop filtering, the filtering of reconstructed video data occurs out of the coding loop, which means that unfiltered versions of the data are stored by an encoder or a decoder for subsequent use in the prediction of subsequent image data.

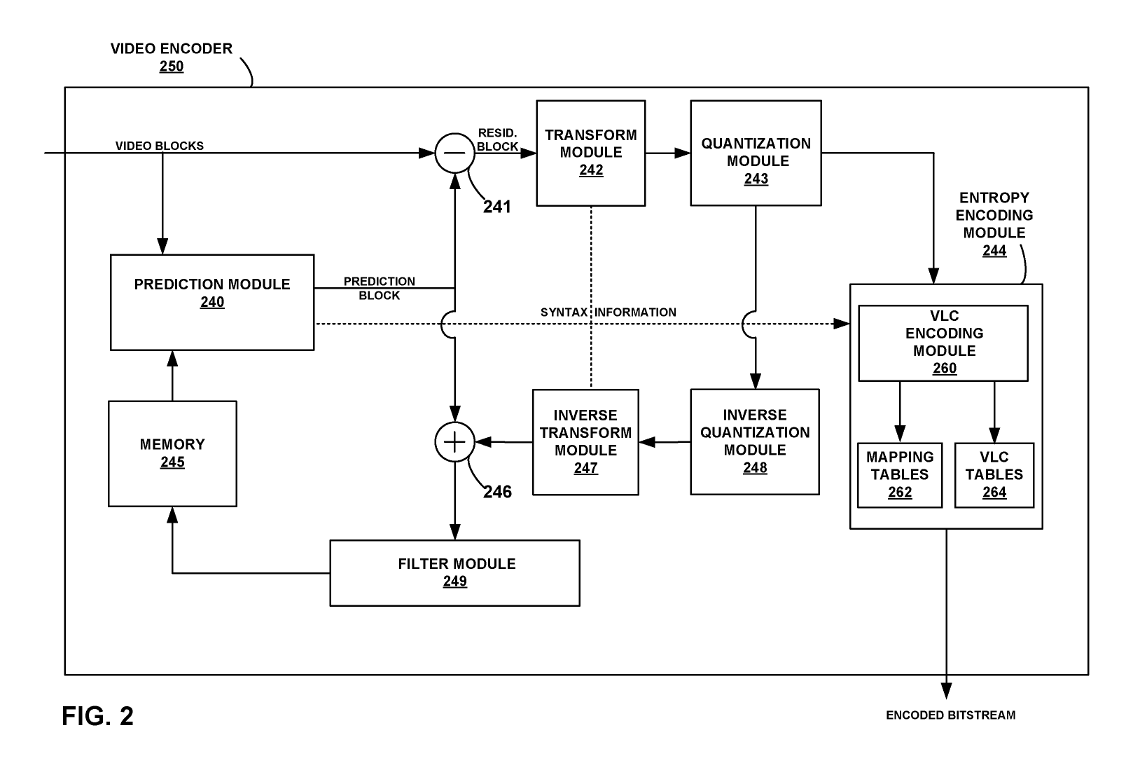

FIG. 2 is a block diagram illustrating an example video encoder 250 consistent with this disclosure. Video encoder 250 may correspond to video encoder 122 of source device 100, or a video encoder of a different device. As shown in FIG. 2, video encoder 250 includes a prediction module 240, adders 241 and 246, and a memory 245. Video encoder 250 also includes a transform module 242 and a quantization module 243, as well as an inverse quantization module 248 and an inverse transform module 247. Video encoder 250 also includes an entropy coding module 244. Entropy coding module 244 includes a VLC encoding module 260.

According to the techniques described herein, VLC encoding module 260 may map determined level_ID and run values to a code number cn. According to some examples, VLC encoding module 260 may map level_ID and run values to a code number cn based on accessing one or more mapping tables 262 (e.g., stored in a memory 245 of video encoder 250). According to other examples, as described herein, VLC encoding module 260 may map level_ID and run values to a code number cn based on a structured mapping (e.g., a mathematical relationship) as described above. According to these examples, entropy coding module 246 may not include one or more mapping tables 262 stored in memory 245 that define a mapping between values level_ID and run and a code number cn. Instead, in some examples, entropy encoding module 262 may store in memory 245 one or more tables (not depicted in FIG. 2) that define a value (e.g., the lrg1Pos value described above) upon which the structured mapping is based. In some examples, the one or more tables that define such a value may require less data to be stored in memory 245 than mapping tables 262.

In some examples, the at least one value (e.g., lrg1Pos) stored in memory 245 may indicate a most likely run value from a current coefficient to a next non-zero coefficient of the block of video data with a magnitude greater than one. In some examples, the at least one value stored in memory 245 may be determined based on a noTr1 value. The noTr1 value may indicate whether or not any previously coded coefficient of the block of video data has a magnitude greater than one. The noTr1 value may instead indicate a number of previously coded coefficients of the block with a magnitude equal to one.

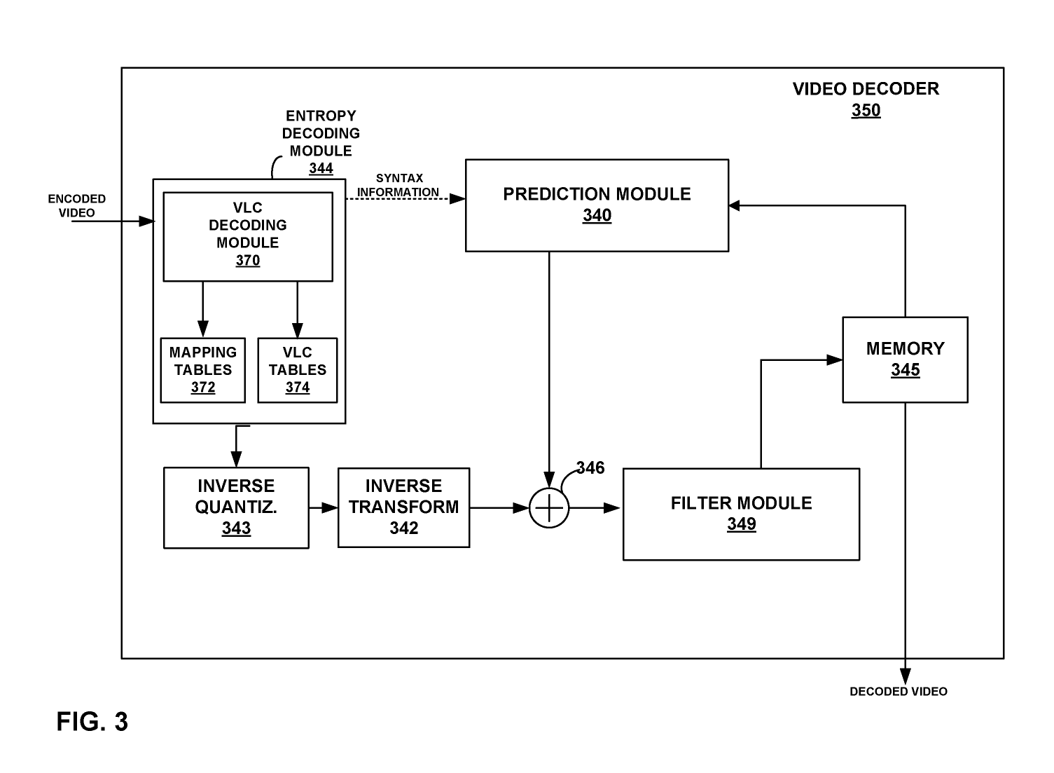

In some examples, the at least one value stored in memory 245 may be determined based on at least one table (not depicted in FIG. 3) stored in memory 245, that defines a relationship between one or more of a position k of a current transform coefficient and/or the noTr1 value and the at least one value stored in memory 245. According to such examples, the one or more tables stored in memory 245 that define the relationship between one or more of position k and/or the noTr1 value and the at least one value stored in memory may consume less memory than the plurality of mapping tables 262 described above.

According to other examples described herein, VLC encoding module 260 may map determined level_ID and run values to a code number cn using a first technique (e.g., a structured mapping) or a second technique (e.g., a mapping table of a plurality of mapping tables 262) based on a coded block type of a block of video data being encoded. For example, if a coded block type of a block of video data is intra-coded luma, VLC encoding module 260 may use the first technique (e.g., a structured mapping) to map determined level_ID and run values to a code number cn. Otherwise, VLC encoding module 260 may use a second technique (e.g., a mapping table of a plurality of mapping tables 262 stored in memory 245) to map determined level_ID and run values to a code number cn.

Once VLC encoding module 260 has determined a code number cn, VLC encoding module 260 may access one or more VLC tables 264 to determine a VLC codeword that represents the level_ID and run values. VLC tables 264 and mapping tables 262 are illustrated as part of entropy coding module 244 insofar as VLC encoding module 260 applies the respective tables. The VLC tables 264 and mapping tables 262, however, may actually be stored in a memory location, such as memory 245, which may be accessible by VLC module 260 to apply the respective tables. Although not depicted in FIG. 2, in some examples as described above, one or more other tables may be used by VLC encoding module to determine a value (e.g., an lrg1Pos value) that defines a structured mapping as described above. According to these examples, such one or more other tables may also be stored in memory 245. For example, such one or more tables may be stored in memory 245 instead of mapping tables 262.

During the encoding process, video encoder 250 receives a video block to be coded, and prediction module 240 performs predictive coding techniques. For inter coding, prediction module 240 compares the video block to be encoded to various blocks in one or more video reference frames or slices in order to define a predictive block. For intra coding, prediction module 240 generates a predictive block based on neighboring data within the same frame, slice, or other unit of video data. Prediction module 240 outputs the predictive block and adder 241 subtracts the predictive block from the video block being coded in order to generate a residual block.

For inter coding, prediction module 240 may comprise motion estimation and motion compensation modules (not depicted in FIG. 2) that identify a motion vector that points to a predictive block and generates the predictive block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. For intra coding, prediction module 240 generates a predictive block based on neighboring data within the same frame, slice, or other unit of video data. One or more intra-prediction modes may define how an intra predictive block can be defined.

Motion compensation for inter-coding may include interpolations to sub-pixel resolution. Interpolated predictive data generated by prediction module 240, for example, may be interpolated to half-pixel resolution, quarter-pixel resolution, or even finer resolution. This permits motion estimation to estimate motion of video blocks to such sub-pixel resolution.

After prediction module 240 outputs the predictive block, and after adder 241 subtracts the predictive block from the video block being coded in order to generate a residual block, transform module 242 applies a transform to the residual block. The transform may comprise a discrete cosine transform (DCT), an integer transform, or a conceptually similar transform such as that defined by the ITU H.264 standard, the HVEC standard, or the like. In some examples, transform module 242 may perform differently sized transforms and may select different sizes of transforms for coding efficiency and improved compression. Wavelet transforms, integer transforms, sub-band transforms or other types of transforms may also be used. In any case, transform module 242 applies a particular transform to the residual block of residual pixel values, producing a block of residual transform coefficients. The transform may convert the residual pixel value information from a pixel domain to a frequency domain.

Inverse quantization module 248 and inverse transform module 247 apply inverse quantization and inverse transform, respectively, to reconstruct the residual block in the pixel domain. Summer 246 adds the reconstructed residual block to the predictive block produced by prediction module 240 to produce a reconstructed video block for storage in memory 245. Filter module 249 may perform in-loop or post loop filtering on reconstructed video blocks.

Memory 245 may store a frame or slice of blocks for use in motion estimation with respect to blocks of other frames to be encoded. Prior to such storage, in the case of in-loop filtering, filter module 249 may apply filtering to the video block to improve video quality. Such filtering by filter module 249 may reduce blockiness or other artifacts. Moreover, filtering may improve compression by generating predictive video blocks that comprise close matches to video blocks being coded. Filtering may also be performed post-loop such that the filtered data is output as decoded data, but unfiltered data is used by prediction module 240.

Quantization module 243 quantizes the residual transform coefficients (e.g., from transform module 242) to further reduce bit rate. Quantization module 243, for example, may limit the number of bits used to code each of the coefficients. After quantization, entropy encoding module 244 may scan and entropy encode the data. For example, entropy encoding module 244 may scan the quantized coefficient block from a two-dimensional representation to one or more serialized one-dimensional vectors. The scan order may be pre-programmed to occur in a defined order (such as zig-zag scanning, inverse zig-zag scanning, horizontal scan, vertical scan, or another pre-defined order), or possibly adaptively defined based on previous coding statistics. Following this scanning process, entropy encoding module 244 encodes the quantized transform coefficients (along with any syntax elements) according to an entropy coding methodology as described herein to further compress the data. Syntax information included in the entropy coded bitstream may include prediction syntax from prediction module 240, such as motion vectors for inter coding or prediction modes for intra coding. Syntax information included in the entropy coded bitstream may also include filter information, such as that applied for interpolations by prediction module 240 or filters applied by filter module 249. In addition, syntax information included in the entropy coded bitstream may also include one or more VLC codewords that represent level_ID and run values associated with transform coefficients of a block of video data, and the techniques of this disclosure specifically define VLC coding of level_ID and run values.

The techniques of this disclosure may be considered a type of CAVLC technique. CAVLC techniques use VLC tables in a manner that effectively compresses serialized “runs” of transform coefficients and/or other syntax elements. Similar techniques might also be applied in other types of entropy coding such as context adaptive binary arithmetic coding (CABAC).

Following the entropy coding by entropy encoding module 244, the encoded video may be transmitted to another device or archived for later transmission or retrieval. Again, the encoded video may comprise the entropy coded vectors and various syntax, which can be used by a decoder to properly configure the decoding process. For example, a decoder may use one or more syntax elements comprising one or more VLC codewords that represent level_ID and run values for transform coefficients, and use the VLC codewords to decode level_ID and run values for the transform coefficients.

FIG. 3 is a block diagram illustrating an example of a video decoder 350, which decodes a video sequence that is encoded in the manner described herein. The received video sequence may comprise an encoded set of image frames, a set of frame slices, a commonly coded group of pictures (GOPs), or a wide variety of coded video units that include encoded video blocks and syntax information to define how to decode such video blocks.

Video decoder 250 includes an entropy decoding module 344, which performs the reciprocal decoding function of the encoding performed by entropy encoding module 244 of FIG. 2. In particular, entropy decoding module 344 may perform CAVLC techniques as described herein as reciprocal entropy coding to that applied by entropy encoding module 244 of FIG. 2. In this manner, entropy decoding module 344 may convert entropy decoded video blocks in a one-dimensional serialized format from one or more one-dimensional vectors of coefficients back into a two-dimensional block format. The number and size of the vectors, as well as the scan order defined for the video blocks may define how the two-dimensional block is reconstructed. Entropy decoded prediction syntax may be sent from entropy decoding module 344 to prediction module 340.

As also depicted in FIG. 3, entropy decoding module 344 includes a VLC decoding module 370. VLC decoding module 370 may receive a VLC codeword that represents the values level_ID and run, and access VLC tables 372 to determine a code number cn. VLC decoding module 370 may further map a determined code number cn to level_ID and run values. Video decoder 350 may use the determined level_ID and run values to decode a block of video data.

According to some examples, VLC decoding module 370 may map a determined code number to level_ID and run values based on accessing a mapping table of a plurality of mapping tables 372 stored in a memory 345 accessible by video decoder 350. According to other examples, as described herein, VLC decoding module 370 may map a determined code number to level_ID and run values based on a structured mapping (e.g., a mathematical relationship) as described above. According to such a structured mapping, VLC decoding module 370 may map a code number cn to level_ID and run values based on at least one value (e.g., an lrg1Pos value) stored in memory 345.

In some examples, the at least one value (e.g., lrg1Pos) stored in memory 345 may indicate a most likely run value from a current coefficient to a next non-zero coefficient of the block of video data with a magnitude greater than one. In some examples, the at least one value stored in memory 345 may be determined based on a noTr1 value. In some examples, the noTr1 value may indicate whether or not any previously coded coefficient of the block of video data has a magnitude greater than one. The noTr1 value may instead indicate a number of previously coded coefficients of the block with a magnitude equal to one. In some examples, the at least one value stored in memory 345 may be determined based on at least one table (not depicted in FIG. 3) stored in memory 345, that defines a relationship between the at least one value stored in memory 345 and one or more of a position k of a current transform coefficient and the noTr1 value. According to such examples, the one or more tables stored in memory that define the relationship between the at least one value stored in memory 345 and one or more of a position k of a current transform coefficient and the noTr1 value may consume less memory than the plurality of mapping tables 372 described above.

According to other examples described herein, VLC decoding module 360 may map a determined code number cn to level_ID and run values using a first technique (e.g., a structured mapping) or a second technique (e.g., by accessing at least one of mapping tables 372) based on a coded block type of a block of video data being decoded. For example, if a coded block type of a block of video data is intra-coded luma, VLC decoding module 360 may use the first technique (e.g. a structured mapping) to map determined level_ID and run values to a code number cn. Otherwise, VLC decoding module 360 may use the second technique (e.g., a mapping table of a plurality of mapping tables 372) to decode the block of video data.

As described above, VLC decoding module 370 may access VLC tables 374 and/or mapping tables 372 to map a code number cn to values of level_ID and run. VLC tables 374 and mapping tables 372 are illustrated as part of entropy decoding module 344 insofar as VLC decoding module 370 applies the respective tables. The VLC tables 372 and mapping tables 374, however, may actually be stored in a memory location, such as memory 345, which may be accessible by VLC decoding module 370 to apply the tables.

As depicted in FIG. 3, video decoder includes a filter module 349. Filter module 349 may perform in-loop or post loop filtering on reconstructed video blocks. Video decoder 350 also includes a prediction module 340, an inverse quantization unit 343, an inverse transform module 342, a memory 345, and a summer 346.

A wide variety of video compression technologies and standards perform spatial and temporal prediction to reduce or remove the redundancy inherent in input video signals. As explained above, an input video block is predicted using spatial prediction (i.e. intra prediction) and/or temporal prediction (i.e. inter prediction or motion estimation). The prediction modules described herein may include a mode decision module (not shown) in order to choose a desirable prediction mode for a given input video block. Mode selection may consider a variety of factors such as whether the block is intra or inter coded, the predictive block size and the prediction mode if intra coding is used, and the motion partition size and motion vectors used if inter coding is used. A predictive block is subtracted from the input video block, and transform and quantization are then applied on the residual video block as described above.

The quantized coefficients, along with the mode information, may be entropy encoded to form a video bitstream. The quantized coefficients may also be inverse quantized and inverse transformed to form the reconstructed residual block, which can be added back to the predictive video block (intra predicted block or motion compensated block depending on the coding mode chosen) to form the reconstructed video block. An in-loop or post-loop filter may be applied to reduce the visual artifacts in the reconstructed video signal. The reconstructed video block is finally stored in the reference frame buffer (i.e., memory) for use of coding of future video blocks.

In some examples, the transform coefficient encoding techniques described in this disclosure may be performed by VLC encoding module 260 of FIG. 2 by using VLC tables 264 and/or mapping tables 262. Again, although VLC tables 264 and mapping tables 262 are illustrated within entropy coding module 244, VLC tables 274 and/or mapping tables 272 may actually be stored in a memory location (such as memory 245) and accessed by VLC encoding module 272 in the coding process. The reciprocal transform coefficient decoding techniques of this disclosure may be performed by VLC decoding module 370 of FIG. 3 by applying VLC tables 374 and/or mapping tables 372. As with VLC module 260, with VLC module 370, VLC tables 374 and mapping tables 372 are illustrated within entropy decoding module 344. This illustration, however, is for demonstrative purposes. In actuality, VLC tables 374 and/or mapping tables 372 may be stored in a memory location (such as memory 345) and accessed by VLC module 370 in the decoding process. The term “coding,” as used herein, refers to any process that includes encoding, decoding or both encoding and decoding.

As described above, to code level_ID and run values according to the techniques described herein, a coding module (e.g., encoding module 250, decoding module 350) may use one or more variable length code (VLC) tables. For example, the coding module may map level_ID and run values to a code number cn. The code number cn may represent an index within a VLC code table.

In some examples, a coder may map level_ID and run values to a code number cn based on accessing at least one mapping table of a plurality of mapping tables (e.g., mapping tables 262, 372 depicted in FIGS. 2 and 3, respectively). The mapping tables may each define a mapping between level_ID and run values to a code number cn.

According to one aspect of this disclosure, instead of accessing such a mapping table, a coding module may map level_ID and run values to a code number cn based on a structured mapping (e.g., a mathematical relationship). In some examples, such a structured mapping may be based at least in part on at least one value (e.g., lrg1Pos) stored in a memory. In some examples, the at least one value stored in memory may be determined by the coding module based on one or more tables stored in memory 345. According to these examples, the one or more tables used to determine the at least one value may consume less memory than the plurality of mapping tables described above.

According to other examples described herein, a coding module (e.g., encoding module 250, decoding module 350) may map between a code number cn to level_ID and run values using a first technique (e.g., a structured mapping) or a second technique (e.g., by accessing at least one of mapping tables 262, 372) based on a coded block type of a block of video data being decoded. For example, if a coded block type of a block of video data is intra-coded luma, the coding module may use the first technique (e.g. a structured mapping) to map determined level_ID and run values to a code number cn. Otherwise, the coding module may use second technique (e.g, a mapping table of a plurality of mapping tables 262, 372) to decode the block of video data.

According to both of these examples, a coding module may use a mapping between a code number cn and level_ID and run values to code transform coefficients. For example, a video encoder 250 may determine a code number cn based on determined level_ID and run values, and use the code number to access a VLC table that includes a VLC codeword. The encoder may send the VLC codeword to a decoder 350. The decoder 350 may receive the VLC codeword, and use the received VLC codeword to determine a code number cn, and use the code number cn to determine level_ID and run values. The decoder 350 may use determined level_ID and run values to decode at least one transform coefficient.

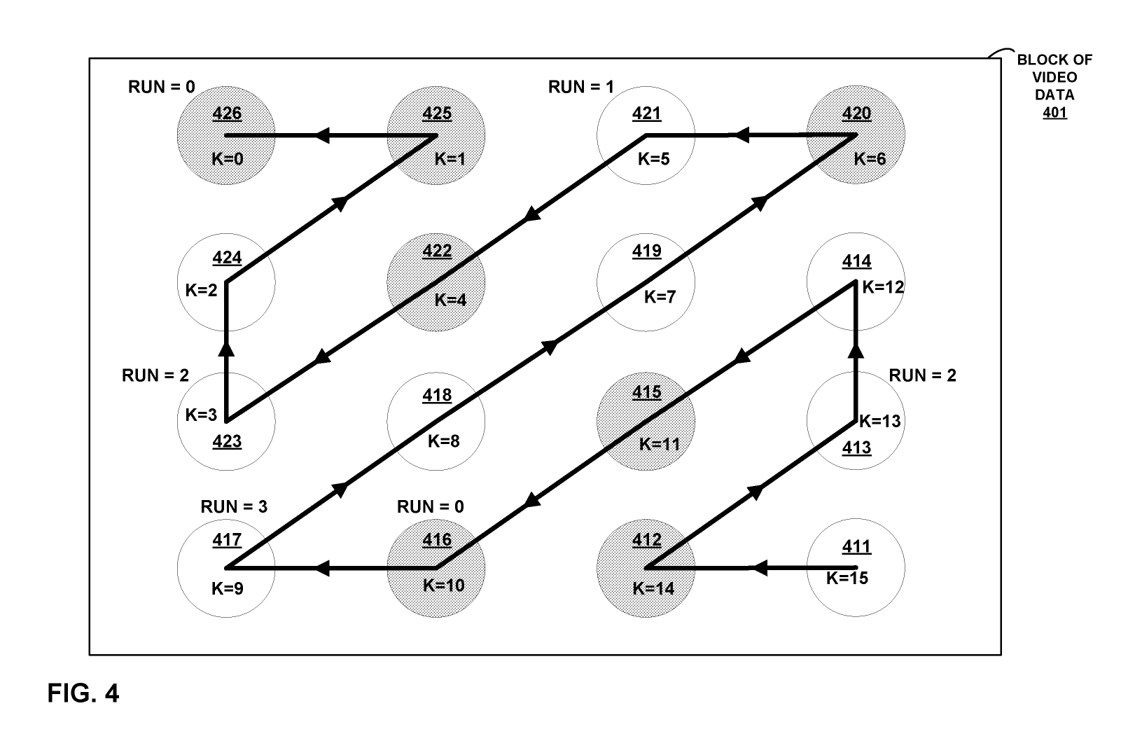

FIG. 4 is a conceptual diagram that illustrates one example of an inverse zig-zag scan consistent with the techniques of this disclosure. The example depicted in FIG. 4 is of a 4×4 block of video data. This example is provided for purposes of explaining the techniques of this disclosure, and is intended to be non-limiting. The techniques described herein may be applicable to any size of video block, and furthermore may be applied to a video block according to any arrangement of video data, including quadtree or macroblock encoding as described above.

As depicted in FIG. 4, block 401 includes sixteen transform coefficients 411-426. According to this example, the transform coefficients are scanned starting at transform coefficient 411 positioned at a lower right corner of block 401 (position k=15 in the example of FIG. 4). The inverse zig-zag scan depicted used to generate a one-dimensional ordered coefficient vector of transform coefficients, that may then be transmitted according to an entropy encoded bitstream.

According to the example of FIG. 4, block 401 includes both non-zero and zero magnitude coefficients 411-426. A non-zero coefficient may refer to a quantized transform coefficient with a magnitude greater than zero (e.g., |level| is greater than zero), while a zero value coefficient may refer to a transform coefficient with a quantized value equal to zero (e.g., |level| is equal to zero). For example as shown in FIG. 4, transform coefficients 412, 415, 416, 420, 422, 425, and 426 (as indicated by shading) are non-zero coefficients, while transform coefficients 411, 413, 414, 417-419, 423, and 424 are zero magnitude transform coefficients.

As described above, based on a current coefficient position, an encoder may signal a level_ID value. The level_ID value may indicate a magnitude of a next non-zero transform coefficient of a scan. For example level_ID may have a value of zero (0) if a magnitude (|level|) of a next non-zero transform coefficient is equal to one. According to this example, level_ID may have a value of one (1) if the magnitude of the coefficient is greater than one. In some examples, an encoder may not signal a level_ID value for zero-magnitude coefficients 411, 413, 414, 417-419, 423, and 424.

As also described above, an encoder may determine a run value for at least some of transform coefficients 411-426. The run value may indicate a number of quantized coefficients with a magnitude equal to zero between a current coefficient and a next non-zero coefficient in a scan order. According to one example, run may have a value in a range from zero to k+1, wherein k is a position index of the current coefficient in a scan. In some examples, an encoder may determine an Run value after each non-zero coefficient of block 401.

FIG. 4 depicts run values after each of non-zero transform coefficients 412, 415, 416, 420, 422, 425, and 426. For example, as shown in FIG. 4, after a coder codes non-zero transform coefficient 412, the coder may signal a run value of run=2, meaning there are two zero value transform coefficients (413, 414) between transform coefficient 412 and a next non-zero coefficient (coefficient 415). As also shown in FIG. 4, after coefficient 415 is coded, the coder may signal a run value of run=0, indicating that there are no zero value coefficients between coefficient 415 and the next non-zero coefficient in the scan order (coefficient 416). As also shown in FIG. 4, after coefficient 416 is coded, the coder may signal a run value of run=3, indicating that there are three zero value coefficients (417-419) between transform coefficient 416 and a next non-zero coefficient (coefficient 420). As also depicted in FIG. 4, after coefficient 420 is coded, the coder may signal a run value of run=1, indicating that there is one zero value coefficient (coefficient 421) between coefficient 420 a next non-zero coefficient (coefficient 422). As also depicted in FIG. 4, after coefficient 422 is coded, the coder may signal a run value run=2, indicating that there are two zero value coefficients (coefficients 423-424) between coefficient 422 and a next non-zero coefficient (coefficient 425). As also depicted in FIG. 4, after coefficient 425 is coded, the coder may signal a run value of run=0, indicating that there are no zero value coefficients between coefficients 425 and 426 in the scan order.

According to a run coding mode, an encoder (e.g., encoder 250) may determine values for run and level_ID based on a current transform coefficient position (e.g., a position k of one or more coefficients 411-426) of a block 401 of video data, and signal the determined run and level_ID values as a VLC codeword. A decoder (e.g., decoder 350) may receive the VLC codeword, and use the VLC codeword to determine the signaled values for run and level_ID. The decoder may use the signaled run and level_ID values to decode the transform coefficients from the current transform coefficient to the next non-zero transform coefficient along the scan order.

As shown in FIG. 4, after coefficient 412 is coded, coeffcient 413 becomes the current coefficient. A run value run=2 and a level_ID value with respect to coeffcient 415 may be signaled (e.g., jointly coded, such as using a concatenated value), based on the position index value k (which is equal to 13 in the example of FIG. 4) for coefficient 413. After coefficient 415 has been coded, coefficient 416 becomes the current coefficient. A run value of 0 and the level_ID value of coefficient 416 may be signaled (e.g., jointly), based on the position index value k (equal to 10 in the example of FIG. 4) of coefficient 416. After coefficient 416 has been coded, coefficient 417 becomes the current coefficient, a run value of 3 and the level_ID value of coefficient 420 may be signaled (e.g., jointly), based on the position index value (equal to 6 in the example of FIG. 4) of coefficient 420 in the scan. In some examples, the coder may continue to determine and signal run and level_ID values with respect to coefficients 421-426, until coefficient 426 is coded.

To signal determined run and level_ID values as a VLC code word, the encoder may map the determined run and level_ID to a code number cn based on the current transform coefficient position. The code number cn may then be used to access at least one VLC table to determine a VLC codeword that represents the determined run and level_ID.

To use the VLC codeword to determine the signaled run and level_ID values, a decoder may determine a code number cn based on a received VLC codeword, and map the code number cn to run and level_ID values based on the current transform coefficient position. The decoder may then use the mapped run and level_ID values to decode the transform coefficients from the current transform coefficient to the next non-zero transform coefficient along the scan order.

In some examples, mapping (e.g., by an encoder or a decoder as described above) between a code number cn and run and level_ID values may include accessing one of a plurality of mapping tables based on a current transform coefficient position. According to these examples, the plurality of mapping tables may include a mapping table for each of a plurality of possible value of position k of transform coefficients, except a very first position of an inverse zig-zag scan (i.e. a last position of a non-inverse zig-zag scan, such as position k=15 illustrated in FIG. 4). According to some examples, a coder may not use run-mode coding to code a coefficient in a last position in scan order. Instead, the coder may use a different coding technique to code the last coefficient. As such, an encoder may not signal run and level_ID values for a last coefficient (e.g., position k=15 in the example of FIG. 4), as described herein. Instead, the coder may begin signaling run and level_ID values at a coefficient after the last coefficient (e.g., a second coefficient of the scan according to an inverse zig-zag scan. For example, according to block 401 depicted in FIG. 4, a 4×4 block of transform coefficients 411-426 includes sixteen possible positions k. As such, according to the example of FIG. 4, a plurality of mapping tables may include fifteen mapping tables that each specifies a mapping between code number cn and run and level_ID values for each of respective position k, except for a position of last coefficient 411 (e.g., position k=15 according to the example of FIG. 4).

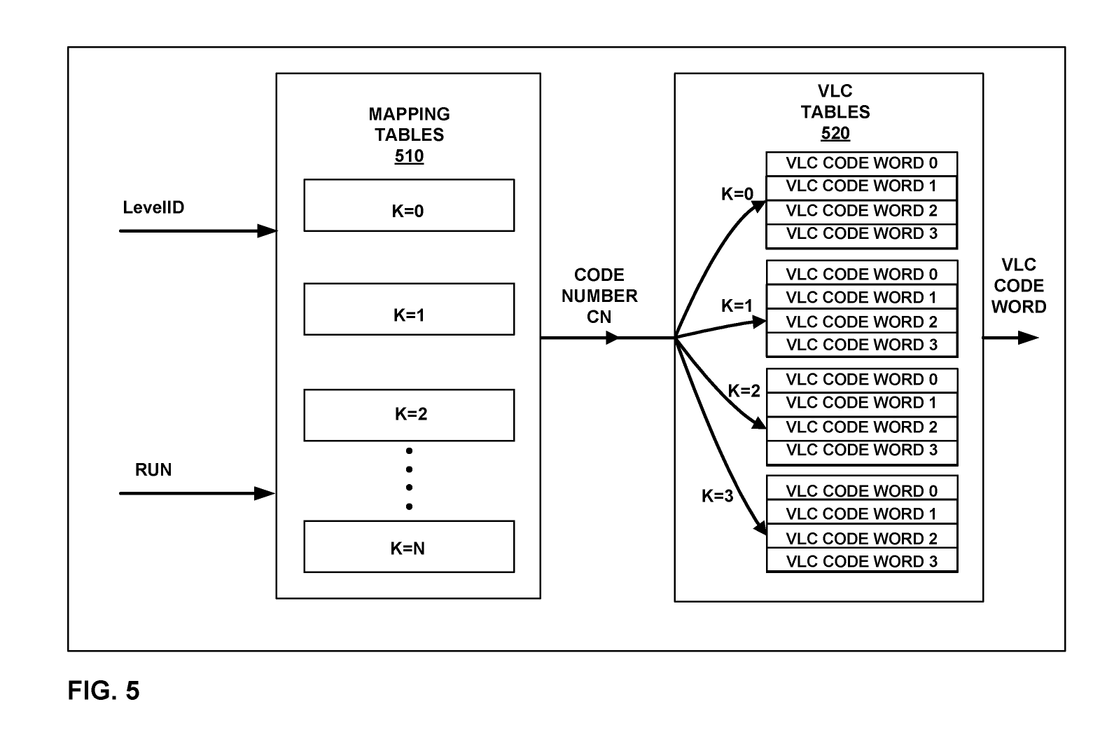

FIG. 5 is a conceptual diagram depicting one example of a technique for encoding transform coefficients of a block of video data consistent with the techniques of this disclosure. For exemplary purposes, the technique of FIG. 5 is described with reference to encoder 250 depicted in FIG. 2, however other devices may be used to perform the techniques depicted in FIG. 5.

As shown in FIG. 5, encoder 250 (e.g., entropy encoding module 244) may determine run and level_ID values based on a current transform coefficient position. In some examples, encoder 250 may determine the run and level_ID values based on the current transform coefficient position in a scan of a plurality of coefficients of a block of video data. In some examples, encoder may signal determined run and level_ID values as a single syntax element, such as an is LevelOne_run syntax element that collectively indicates both the run and level_ID values.

In some examples, the scan may comprise an inverse zig-zag scan as depicted and described with respect to FIG. 4. Also, in some examples, the encoder may be configured to switch between level and run mode encoding as also described above.

The level_ID value mentioned above may indicate whether a next non-zero coefficient has a magnitude of one or greater than one. For example, to determine a level_ID value, encoder 250 may determine a magnitude of a non-zero transform coefficient. If the determined magnitude of the transform coefficient is equal to one, encoder 250 may determine a level_ID value of zero (0) for the transform coefficient. However, if the determined magnitude is greater than one, encoder 250 may determine a level_ID value of one (1) for the transform coefficient.

Encoder 250 may further determine a run value based on the current transform coefficient position. The run value may indicate a number of quantized coefficients with a magnitude equal to zero between a current (currently coded) coefficient and a next non-zero coefficient in a scan order (e.g., an inverse zig-zag scan order). According to one example, run may have a value in a range from zero to k+1, where k is a position index of the current non-zero coefficient in a scan. To determine a run value based on a current coefficient position, encoder 250 may determine respective magnitudes of other coefficients of a video bock (e.g., other coefficients of block 401 depicted in FIG. 4). Encoder may further identify a next non-zero coefficient of the block (e.g., which of the coefficients have a magnitude greater than zero). Encoder 250 may determine a run from the current transform coefficient position based on a number of zero value coefficients between the current coefficient position and the identified next non-zero coefficient in the scan order.

Once the values of run and level_ID have been determined based on a current transform coefficient position, encoder 250 (e.g., VLC encoding module 260) may map the determined run and level_ID values to a code number cn. According to one aspect of this disclosure, as depicted in FIG. 5, encoder 250 may map the determined run and level_ID values to a code number cn based on using a mapping table of a plurality of mapping tables 510. Mapping tables 510 may be stored in a memory accessible by encoder 250, such as memory 245 depicted in FIG. 2. According to the example of FIG. 5, mapping tables 510 include a mapping table dedicated for each potential value for position k of a current transform coefficient. In some examples, as encoder 250 proceeds through a scan of transform coefficients, the encoder may determine values for position k each coefficient.

According to the example of FIG. 5, a first mapping table of mapping tables 510 is dedicated to a position k=0. The position k=0 may indicate that a current coefficient is at a first position in a scan order (e.g., a position of coefficient 426 depicted in FIG. 4) or a last position in an inverse scan order. As shown in FIG. 5, mapping tables 510 include a plurality of tables each dedicated to a position k=0 to a position k=N. The value N may represent a number of coefficient positions of a scan excluding the very first coefficient position in an inverse scan (e.g. position k=15 of coefficient 411 according to the example of FIG. 4). For example, according to the 4×4 block of transform coefficients depicted in FIG. 4, N may have a value of fifteen, because there are sixteen coefficients in block 401.

As encoder 250 proceeds through a scan of transform coefficients, encoder 250 may determine values for position k for each coefficient of the scan (e.g., each non-zero coefficient of the scan). Based on the determined values, encoder 250 (e.g., VLC encoding module 260) may select a mapping table of mapping tables 510. Encoder may enter determined run and level_ID values to a selected mapping table to determine a code number cn based on a current transform coefficient position. The code number cn may comprise an index within a VLC table in a plurality of VLC tables.

As also depicted in FIG. 5, encoder 250 may have a plurality of VLC tables 520 which, like mapping tables 510 may be stored in a memory accessible by encoder 250. As depicted in FIG. 5, VLC tables 520 include a plurality of VLC tables each dedicated to possible coefficient positions k of a scan. For example, according to video block 401 depicted in FIG. 4, VLC tables 520 may include fifteen VLC tables, each dedicated to the fifteen potential coefficient positions in video block 401 except the very first position (e.g., position k=15 of coefficient 411 according to the example of FIG. 4). For ease of illustration, the example of FIG. 5 shows VLC tables 520 only includes four VLC tables, each dedicated to positions k from zero to three. In other examples, not depicted in FIG. 4, VLC tables 520 may include many more VLC tables than depicted in FIG. 4. For example, VLC tables 520 may include a VLC table for each coefficient position of a block except the very first position along an inverse scan order (e.g., fifteen VLC tables according to the example of FIG. 4).

Furthermore, each of the VLC tables depicted in FIG. 5 includes four codewords (VLC codeword 1, VLC codeword 2, VLC codeword 3, VLC codeword 4). The respective codewords may be different between the tables. For example, VLC codeword 1 of the VLC table dedicated to a position k=1 may be a different VLC codeword than VLC codeword 1 of the VLC table dedicated to a position k=2. In addition, each of the VLC tables depicted in FIG. 5 each include a same number of VLC codewords (four VLC code words). In other examples not depicted in FIG. 5, one or more of the VLC tables may include more, or fewer, VLC codewords than other VLC tables.

Once encoder 250 (e.g., VLC encoding module 260) determines a code number cn, encoder 250 may use the code number to access one of VLC tables 520 to determine a VLC codeword that represents determined run and level_ID values. For example, according to the example of FIG. 5, a code number cn may have a value of three. The code number value of three may indicate that, for each of the depicted VLC tables (k=0, k=1, k=2, k=3), a VLC codeword corresponding to a fourth position within the respective table. Encoder 250 may select a VLC table of VLC tables 520 based on a position k of a current transform coefficient, and based on a determined code number cn, determine a VLC codeword that represents determined run and level_ID values. Encoder 250 may signal the determined VLC codeword to a decoder, such as decoder 350. For example, encoder 250 may signal the determined VLC codeword as part of an entropy encoded bit stream of video data.

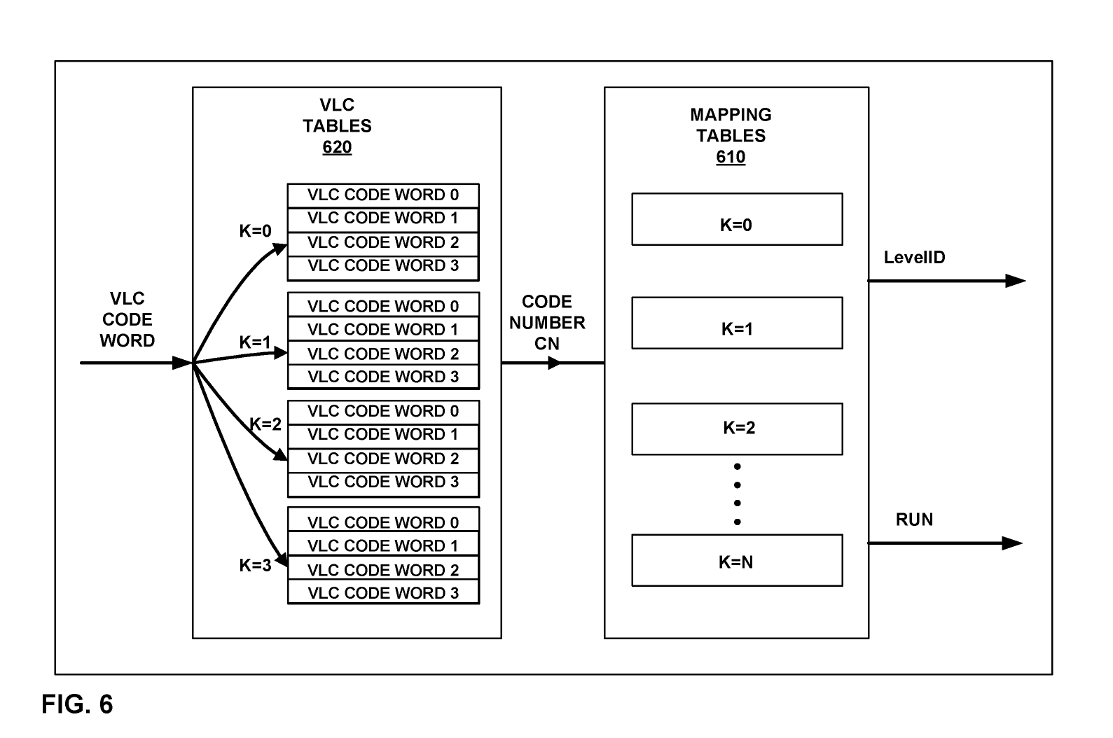

FIG. 6 is a conceptual diagram depicting one example of a technique for decoding transform coefficients of a block of video data consistent with the techniques of this disclosure. For exemplary purposes, the techniques of FIG. 6 are described with reference to decoder 350 depicted in FIG. 3, however any decoding device may be used to perform the techniques depicted in FIG. 6.

According to the example of FIG. 6 decoder 350 (e.g., VLC decoding module 370) determines signaled run and level_ID values based on a received VLC codeword. As depicted in FIG. 6, like encoder 250, decoder 350 includes a plurality of mapping tables 610 and a plurality of VLC tables 620. In some examples, mapping tables 610 and VLC tables 620 of decoder 350 are substantially the same tables as mapping tables 510 and VLC tables 520 of encoder 250, respectively.

As shown in FIG. 6, decoder 350 may receive a VLC codeword from an encoder 250. The decoder 350 has access to VLC tables 620, each dedicated to a particular position k of a currently coded coefficient. Based on determined position k of the current coefficient, decoder 350 may select a VLC table, and use the VLC table to decode the received VLC codeword and determine a code number cn. Decoder 350 may map the determined code number cn to run and level_ID values to decode coefficients from the current coefficient to the next non-zero coefficient along a scan order.

As depicted in FIG. 6, decoder 350 may have access to mapping tables 610. For example, mapping tables 610 may be stored in memory 345 accessible by decoder 350. As described above with respect to mapping tables 510 depicted in FIG. 5, mapping tables 610 may include mapping tables dedicated to each potential value of position k for a video block being decoded. Decoder 350 may determine a position k for a transform coefficient, and select one of mapping tables 610 based on the determined position k. Decoder 350 may use the selected mapping table to decode to determine values of run and level_ID. Decoder 350 may use the determined run and level_ID values to decode transform coefficients from a current coeffcient to the next non-zero coefficient along a scan order.

According to the techniques described above with respect to FIGS. 5 and 6, a coder (e.g., encoder, decoder) may determine a mapping between run and level_ID values and a code number cn based selecting a mapping table of a plurality of mapping tables 510, 610 stored in a memory accessible to the coder. Such techniques may be undesirable, where an amount of memory available to the coder is limited. According to one aspect of this disclosure, a coder may be configured to map between a code number cn and level_ID and run values based on a structured mapping. As such, the coder may not store a plurality of mapping tables 510, 610 a memory accessible by the coder. As such, coding efficiency may be improved.

According to another aspect of this disclosure, a coder (e.g., VLC encoding module 260 depicted in FIG. 2, VLC decoding module 270 depicted in FIG. 3) may be configured to map between a code number cn and level_ID and run values using first or second techniques based on a coded block type of a block of video data being coded. For example, if the coded block type of the block of video data is intra-coded luma, the coder may use a first technique that includes performing a structured mapping (e.g., without using mapping tables 510, 610 depicted in FIGS. 5 and 6). Otherwise, the coder may use a mapping table of a plurality of mapping tables 510, 610 as depicted in FIGS. 5 and 6.

Example 1 below illustrates one example of pseudo code that may be used by an encoder to implement a structured mapping as described above.

### Example 1

```
                    if (level_ID==0){
    if (run<lrg1Pos) {
        cn=run;
    }
    else {
        cn=2*run−lrg1Pos+1;
    }
}
else{
    if (run>(k−lrg1Pos+1)) {
        cn=k+run+2;
    }
    else {
        cn=lrg1Pos+2*run;
    }
}
```

The pseudo code of Example 1 may be stored in a memory of an encoder so that the encoder is able to map run and level_ID values to a code number cn based on a current coefficient position k when needed.

The pseudo code of Example 1 above may operate based on a value lrg1Pos. For example, as illustrated by the above pseudo code, an encoder may determine run (“run” in the above pseudo code) and level_ID value based on a current transform coefficient position k and/or determined magnitudes of one or more other transform coefficients of a block of video data. The encoder may further determine a value noTr1 based on one or more previously coded transform coefficients as described above. The encoder may further determine a value lrg1Pos based on the position k and the determined noTr1 value for the current coefficient. For example, the encoder may access a table stored in a memory accessible to the encoder that indicates a mapping between determined k and noTr1 values and lrg1Pos values. Example 2 below depicts one example of a table that defines a mapping from a plurality of potential values of position k for a determined noTr1 value of 1 to values of lrg1Pos. Similar tables may also be used for other values of noTr1.

TABLE 1
(noTr1 = 1):

| | Position k | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| lrg1Pos | 2 | 3 | 4 | 5 | 6 | 5 | 6 | 7 | 7 | 7 | 7 | 7 | 6 | 4 | 2 |

An encoder may access a table such as depicted in Table 1 based on a determined value noTr1 and/or a position k for a current transform coefficient. For example, if the encoder determines that the value of noTr1 for a current coefficient is equal to 1, the encoder may access the table depicted in Example 2. If the encoder determines a different value of noTr1 for the current coefficient, the encoder may access a different table stored in memory.

Based on a determined value of lrg1Pos, an encoder may perform a structured mapping using pseudo code such as described above with respect to Example 1. For example, if a value of level_ID is equal to zero (e.g., indicating that a magnitude of the non-zero coefficient is equal to one), the coder may determine whether a value of run (e.g., a number of zero value coefficients between a current coefficient and the next non zero coefficient) is less than the value lrg1Pos. As shown by Example 1, if run is less than the value lrg1Pos, then the encoder assigns a value of run to the code number cn. However, if run is greater than or equal to the value lrg1Pos, then the coder may assign code number cn a value of two times a value of run minus the value lrg1Pos plus one.

According to the pseudo code of Example 1, if a value of level_ID for a next non-zero transform coefficient is not equal to zero (e.g., indicating that the coefficient has a magnitude greater than one), then the encoder may compare a value of run to a value k-lrg1Pos+1. If a value of run is greater than the value k-lrg1Pos+1, then the coder may assign the code number cn a value of position k plus a value of run plus two. Otherwise, the coder may assign the code number cn a value of lrg1Pos plus two times a value of run.

The pseudo code of Example 1 depicts a structured mapping of run and level_ID values to a code number cn. Operation of the above pseudo code is based on known input values of run and level_ID. As such, an encoder 250 may determine values of run and level_ID, and apply the pseudo code described above to directly determine a code number cn.

In some examples, a decoder (e.g., video decoder 350) may also be configured to map between a code number cn and run and level_ID values based on a value lrg1Pos. For example, the decoder may determine a position k and/or a noTr1 for a current transform coefficient as described above with respect to an encoder, and access a table such as Table 1 above to determine the lrg1Pos value for the coefficient (e.g., if the noTr1 value is equal to one, otherwise the decoder may access a different table). Example 2 below is pseudo code that may be used by a decoder to perform a structured mapping.

### Example 2

```
if (cn < min(lrg1Pos, k+2)) {
    level_ID = 0;
    run = cn;
}
else if (cn < k*2 + 4 − lrg1Pos) {
    if (the value of (cn+lrg1Pos) is an odd number ){
        level_ID = 0;
        run = (cn + lrg1Pos − 1) >> 1;
    }
    else {
        level_ID = 1;
        run = (cn − lrg1Pos)>>1;
    }
}
else {
    level_ID = 1;
    run = cn − maxrun − 2;
}
```

According to the pseudo code of Example 2, a decoder may determine whether a determined code number cn is less than the lesser of the value lrg1Pos for a coefficient, or a position k of the coefficient plus two. If the determined code number cn is less than the lesser of the value lrg1Pos for a coefficient, or a position k of the coefficient plus two, then the decoder may assign a value of one (1) to level_ID, and a value of the code number cn to run.

Also according to the pseudo code of Example 2, if the determined code number cn is not less than (i.e. greater than or equal to) the lesser of the value lrg1Pos for a coefficient, or a position k of the coefficient plus two, then the decoder may determine whether the code number cn is less than the position k multiplied by two, plus four, minus the value lrg1Pos. If the code number cn is less than the position k multiplied by two, plus four, minus the value lrg1Pos, then the decoder may determine whether the value of (cn+lrg1Pos) is an odd number. If the value of (cn+lrg1Pos) is an odd number, the decoder may assign level_ID a value of zero (0), and run a value of the code number cn plus the value lrg1Pos minus 1, divided by 2. Otherwise, the decoder may assign level_ID a value of one (1), and run a value of the code number minus the value lrg1Pos divided by two.

Also according to the pseudo code of Example 2, if the determined code number cn is not less than (i.e. greater than or equal to) the lesser of the value lrg1Pos for a coefficient, or a position k of the coefficient plus two, and the code number cn is less than the position k multiplied by two, plus four, minus the value lrg1Pos, then the decoder may assign level_ID a value of 1, and run a value of the code number cn minus a position k of the coefficient minus two.

Table 2 below illustrates a coefficient specific mapping table that may be generated based on a structured mapping, such as described with respect to the pseudo code reproduced above. The example of Table 2 below is provided for purposes of explaining the techniques of this disclosure. In operation, an encoder may not generate and/or store a table as depicted in Table 2. Instead, the encoder may determine the values for code number cn depicted in Table 2 on the fly, without needing to generate and/or store a table as depicted in Table 2. The example of Table 2 assumes a value of lrg1Pos with a value of four, and a position k with a value of six. The lrg1Pos value of four may be determined by a coder based on a table such as Table 1 above (e.g., based on a position k and/or a value noTr1 of a transform coefficient). The position k of six may be a position of a current coefficient of a scan.

TABLE 2

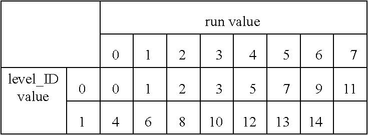

According to example of Table 2, rows of the table represent values of level_ID, while columns of the table represent values of run. The shaded region depicted in Table 2 shows values of code number cn assigned based on the pseudo code of Example 1 reproduced above. According to the example of Table 2, level_ID has two possible values, zero or one, and run has eight possible values 0-7 based on a given position k=6 of a current coefficient. According to an example 4×4 block of video data that includes sixteen transform coefficients as depicted with respect to FIG. 4, a position k=6 (e.g., a tenth coefficient in inverse scan order), may possibly have eight possible values (i.e. from k=0 to k=7) of run in the scan order.

As depicted in Table 2, for level_ID value 0, if run has a value of less than lrg1Pos (less then lrg1Pos=four in the example of Table 1), then the code number is assigned a value equal to a value of run. For example, as depicted in Table 2, if level_ID has a value of zero, for a run value of zero, the code number cn is assigned a value of zero, for a run value of one, the code number cn is assigned a value of one, for a run value of two, the code number cn is assigned a value of two, for a run value of three, the code number cn is assigned a value of 3.

If run is greater than or equal to lrg1Pos (greater than or equal to lrg1Pos=four), then the code number cn is assigned a value of two times a value of run minus the value lrg1Pos plus one. As such, according to the example of Table 2, if level_ID has a value of zero, for a run value of four, the code number is assigned a value of five, for an run value of five, the code number is assigned a value of seven, for a run value of six, the code number is assigned a value of nine, for a run value of seven, the code number is assigned a value of eleven.

As depicted in Table 2, for a level_ID value of 1, if run has a value less than or equal to k-lrg1Pos+1 (less than or equal to six minus four plus one equals three in the example of Table 2), then the code number is assigned a value of lrg1Pos (equal to four in the example of Table 2), plus two times a value of run. For example, as depicted in Table 2, if level_ID has a value of one, for a run value of zero, the code number cn is assigned a value of four, for a run value of one, the code number cn is assigned a value of six, for a run value of two, the code number cn is assigned a value of eight, for a run value of three, the code number cn is assigned a value of ten.

As also depicted in Table 2, for a level_ID value of one, if run has a value greater than the value k-lrg1Pos+1 (greater than six minus four plus one equals three in the example of Table 2), the code number cn is assigned a value of position k (equal to 6 in the example of Table 2) plus a value of run, plus two. For example, as depicted in Table 2, if level_ID has a value of one, for an run value of four, the code number cn is assigned a value of twelve, for a run value of five, the code number cn is assigned a value of thirteen, for a run value of six, the code number is assigned a value of fourteen.

The pseudo code of Examples 1 and 2 and corresponding Tables 1 and 2 reproduced above describe one example of a structured mapping between a code number cn and level_ID and run values for transform coefficients. Examples 1 and 2 and Tables 1 and 2 merely describe one possible implementation of a structured mapping between a code number cn and level_ID and run values for transform coefficients. According to other examples not explicitly described herein, such a structured mapping may be performed using other mathematical relationships.

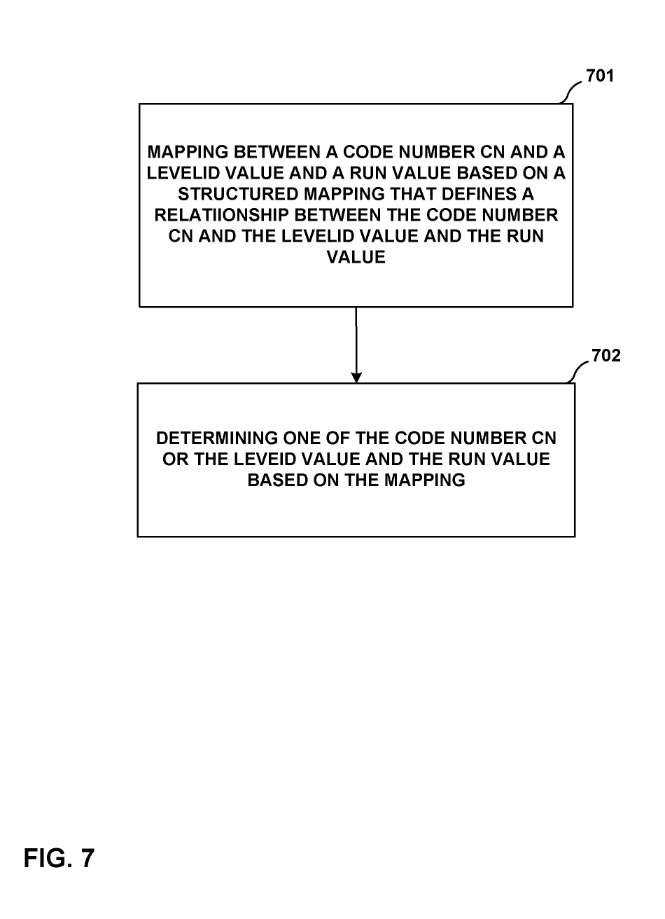

FIG. 7 is a flow diagram that illustrates one example of a method of coding (e.g., encoding or decoding) a block of video data consistent with the techniques of this disclosure. As depicted in FIG. 7, an coding module (e.g., video encoder 250 depicted in FIG. 2, video decoder 350 depicted in FIG. 3), may map between a code number cn and a level_ID value and a run value based on a structured mapping that defines a relationship between the code number cn and the level_ID value and the run value (701). As also depicted in FIG. 7, the coding module may determine one or more of the code number cn or the level_ID value and the run value based on the mapping (702).

The level_ID value indicates, with respect to a position of a current transform coefficient, whether a next non-zero transform coefficient of a block of video data has a magnitude of one or greater than one. The run value indicates a number of zero value transform coefficients of the block, from the current transform coefficient to the next non-zero transform coefficient of the block of video data. In some examples, mapping based on the structured mapping includes mapping based on a mathematical relationship between the code number cn and the level_ID value and the run value.

In some examples, the coding module may map based on a position of the current transform coefficient and/or a most likely run value from the current coefficient to a next non-zero coefficient of the block of video data with a magnitude greater than one. In some examples, the coding module may map based on at least one value (e.g., an lrg1Pos value) stored in a memory (e.g., memory 245, 345 depicted in FIGS. 2 and 3, respectively) that indicates a most likely run value from the current coefficient to a next non-zero coefficient of the block of video data with a magnitude greater than one.

In some examples, the coding module may determine the at least one value (e.g., lrg1Pos) stored in memory. For example, the coding module may determine the at least one value stored in memory based on one or more of a position k and/or a noTr1 value for the current transform coefficient. The noTr1 value indicates whether at least one other previously coded transform coefficient of the block has a magnitude greater than one. In some examples, determining the at least one value stored in memory based on accessing at least one table stored in the memory that defines the at least one value based on one or more of the position k and the noTr1 value for the current transform coefficient.

In some examples, mapping between a code number cn and level_ID and run values based on a structured mapping as depicted in FIG. 7 may be advantageous, because the coding module may not store a plurality of mapping tables (e.g., mapping tables 510, 610 depicted in FIGS. 5 and 6, respectively), which may consume significantly more memory that the at least one value stored in memory, and/or the at least one table used to determine the at least one value stored in memory as described above.

As depicted in FIG. 7, the coding module may perform a mapping between a code number cn and level_ID and run values and determine one or more of the code number cn or the level_ID value and the run value based on the mapping. For example, the coding module may be a video decoder as depicted in FIG. 3. According to these examples, decoding module 350 may further receive a VLC codeword. Decoding module 350 may further determine a code number cn based on the received VLC codeword. Decoding module 350 may further determine the level_ID value and the run value based on the structured mapping between the code number cn and the level_ID value and the run value. Decoding module 350 may use the determined level_ID value and the determined run value to decode a block of video data.

According to other examples, the coding module may be a video encoder 250 as depicted in FIG. 2. According to these examples, video encoder 250 may determine the level_ID value and the run values. Video encoder 250 may use the structured mapping to determine a code number cn based on the determined level_ID value and the determined run value. Video encoder 250 may further use the determined code number cn to determine a VLC code word that represents the determined level_ID value and the determined run value. Video encoder 250 may output the determined VLC code word. For example, video encoder 250 may communicate the determined VLC code word to a video decoder (e.g., video decoder 350 depicted in FIG. 3). The video decoder may use the received VLC code word to decode a block of video data.

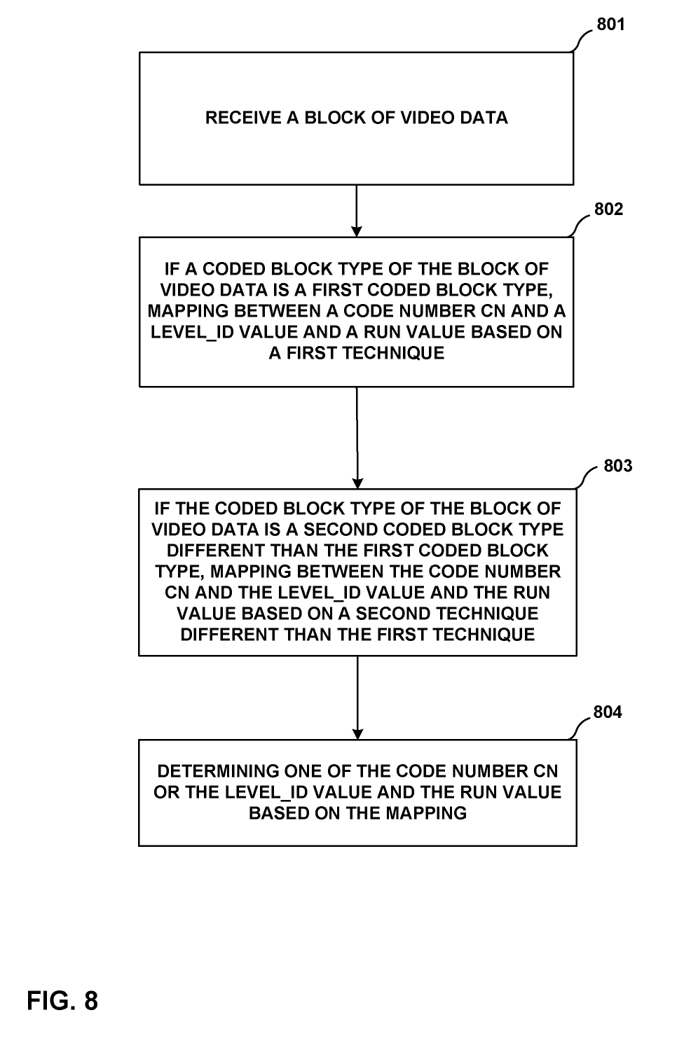

FIG. 8 is a flow diagram that illustrates one example of a method of encoding transform coefficients of a block of video data. As depicted in FIG. 8, a coding module (e.g., video encoder 250, video decoder 350 depicted in FIGS. 2 and 3) may receive a block of video data (801). If a coded block type of the block of video data is a first coded block type, then the coding module may map between the code number cn and the level_ID value and the run value based on a first technique (802). However, if the coded block type of the block of video data is a second coded block type different than the first coded block type, then the coding module may map between the code number cn and the level_ID value and the run value based on a second technique different than the first technique (803). As also shown in FIG. 8, the coding module may determine one of the code number cn or the level_ID value and the run value based on the mapping (804).

In some examples, mapping based on the first technique includes mapping based on a structured mapping as described above with respect to FIG. 7. In some examples, mapping based on the second technique includes mapping based on at least one mapping table stored in memory, as described above with respect to FIGS. 5 and 6. In some examples, mapping according to the first technique may include mapping without accessing the at least one mapping table stored in a memory (e.g., memory 245, 345 depicted in FIGS. 2 and 3, respectively). In some examples, the first coded block type may include an intra-coded luma coded block type. In some examples, the second coded block type different than the first coded block type may include one or more of an intra-coded chroma, inter-coded luma, or inter-coded chroma coded block type.

In some examples, the method depicted in FIG. 8 may be performed by a decoder (e.g., decoder 350 depicted in FIG. 3). According to these examples, decoder 350 may receive a VLC code word. Decoder 350 may further determine the code number cn based on the received VLC code word. Decoder 350 may further determine the level_ID value and the run value based on mapping according to the first technique or the second technique described above, dependent on the coded block type of the block of video data. Decoder 350 may further use the determined level_ID value and the determined run value to decode the block of video data.

According to other examples, the method depicted in FIG. 8 may be performed by an encoder (e.g., encoder 250 depicted in FIG. 2). According to these examples, the encoder may determine the level_ID value and the run value the current transform coefficient. Encoder 250 may map from the determined level_ID value and the determined run value to determine the code number cn. Encoder 250 may further determine the VLC codeword based on the determined code number cn. Encoder 250 may further output the determined VLC codeword. For example, encoder 250 may output the determined VLC codeword to a decoder (e.g., decoder 350 depicted in FIG. 3). The decoder may then use the VLC codeword to decode the block of video data.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples been described. These and other examples are within the scope of the following claims.

1. A method of decoding a block of video data, comprising:
determining a code number cn based on a VLC codeword;
determining a level_ID value and a run value associated with a transform coefficient of the block of video data using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data; and
using at least one of the determined level_ID value and the determined run value to decode the block of video data.

2. The method of claim 1, wherein using the structured mapping comprises:
mapping based on a mathematical relationship between the code number cn and the level_ID value and the run value.

3. The method of claim 1, wherein using the structured mapping further comprises:
mapping based on a most likely run value from the current coefficient to a next non-zero coefficient of the block of video data with a magnitude greater than one.

4. The method of claim 1, wherein using the structured mapping further comprises:
mapping based on a position of the current transform coefficient.

5. The method of claim 1, wherein using the structured mapping further comprises:
mapping based on at least one value stored in a memory.

6. The method of claim 5, wherein using the structured mapping further comprises:
determining the at least one value stored in memory based on a most likely run value from the current coefficient to a next non-zero coefficient of the block of video data with a magnitude greater than one.

7. The method of claim 5, further comprising:
determining the at least one value stored in memory based on a noTr1 value for a currently coded transform coefficient, wherein the noTr1 value indicates whether at least one other previously coded transform coefficient of the block has a magnitude greater than one.

8. The method of claim 5, further comprising:
determining the at least one value stored in memory based on accessing at least one table stored in the memory that defines the at least one value.

9. The method of claim 5, wherein the at least one value stored in memory comprises an lrg1Pos value.

10. The method of claim 1, wherein mapping based on the structured mapping comprises:
mapping without using a mapping table stored in memory that defines the relationship between the code number cn and the level_ID value and the run value.

11. A device for decoding a block of video data, comprising:
a VLC decoding module configured to:
determine a code number cn based on a VLC codeword;
determine a level_ID value and a run value associated with a transform coefficient of the block of video data using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data; and
use at least one of the determined level_ID value and the determined run value to decode the block of video data.

12. The device of claim 11, wherein using the structured mapping comprises:
mapping based on a mathematical relationship between the code number cn and the level_ID value and the run value.

13. The device of claim 11, wherein using the structured mapping comprises:
mapping based on a most likely run value from the current coefficient to a next non-zero coefficient of the block of video data with a magnitude greater than one.

14. The device of claim 11, wherein using the structured mapping further comprises:
mapping based on a position of the current transform coefficient.

15. The device of claim 11, wherein using the structured mapping further comprises:
mapping based on at least one value stored in a memory associated with the VLC decoding module.

16. The device of claim 15, wherein using the structured mapping further comprises:
determining the at least one value stored in the memory based on a most likely run value from the current coefficient to a next non-zero coefficient of the block of video data with a magnitude greater than one.

17. The device of claim 15, further comprising:
determining the at least one value stored in memory based on a noTr1 value for a currently coded transform coefficient, wherein the noTr1 value indicates whether at least one other previously coded transform coefficient of the block has a magnitude greater than one.

18. The device of claim 15, further comprising:
determining the at least one value stored in memory based on accessing at least one table stored in the memory that defines the at least one value.

19. The device of claim 15, wherein the at least one value stored in memory comprises an lrg1Pos value.

20. The device of claim 11, wherein mapping based on the structured mapping comprises:
mapping without using a mapping table stored in memory that defines the relationship between the code number cn and the level_ID value and the run value.

21. A device for coding a block of video data, comprising:
means for determining a code number cn based on a VLC codeword;
means for determining a level_ID value and a run value associated with a transform coefficient of the block of video data using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data; and
means for using at least one of the determined level_ID value and the determined run value to decode the block of video data.

22. A computer-readable storage medium that stores instructions configured to cause a computing device to:
determine a code number cn based on a VLC codeword;
determine a level_ID value and a run value associated with a transform coefficient of the block of video data using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data; and
use at least one of the determined level_ID value and the determined run value to decode the block of video data.

23. A method of encoding a block of video data, comprising:
determining a level_ID value and a run value associated with a transform coefficient of the block of video data
determining a code number cn based on the determined level_ID value and the determined run value using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data;
determining a VLC codeword based on the determined code number cn; and
outputting the determined VLC codeword.

24. The method of claim 23, wherein using the structured mapping comprises:
mapping based on a mathematical relationship between the code number cn and the level_ID value and the run value.

25. The method of claim 23, wherein using the structured mapping further comprises:
mapping based on a most likely run value from the current coefficient to a next non-zero coefficient of the block of video data with a magnitude greater than one.

26. The method of claim 23, wherein using the structured mapping further comprises:
mapping based on a position of the current transform coefficient.

27. The method of claim 23, wherein using the structured mapping further comprises:
mapping based on at least one value stored in a memory.

28. The method of claim 27, wherein using the structured mapping further comprises:
determining the at least one value stored in memory based on a most likely run value from the current coefficient to a next non-zero coefficient of the block of video data with a magnitude greater than one.

29. The method of claim 27, further comprising:
determining the at least one value stored in memory based on a noTr1 value for a currently coded transform coefficient, wherein the noTr1 value indicates whether at least one other previously coded transform coefficient of the block has a magnitude greater than one.

30. The method of claim 27, further comprising:
determining the at least one value stored in memory based on accessing at least one table stored in the memory that defines the at least one value.

31. The method of claim 27, wherein the at least one value stored in memory comprises an lrg1Pos value.

32. The method of claim 23, wherein mapping based on the structured mapping comprises:
mapping without using a mapping table stored in memory that defines the relationship between the code number cn and the level_ID value and the run value.

33. A device for encoding a block of video data, comprising:
a VLC encoding module configured to:
determine a level_ID value and a run value associated with a transform coefficient of the block of video data
determine a code number cn based on the determined level_ID value and the determined run value using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data;
determine a VLC codeword based on the determined code number cn; and
output the determined VLC codeword.

34. The device of claim 33, wherein using the structured mapping comprises:
mapping based on a mathematical relationship between the code number cn and the level_ID value and the run value.

35. The device of claim 33, wherein using the structured mapping comprises:
mapping based on a most likely run value from the current coefficient to a next non-zero coefficient of the block of video data with a magnitude greater than one.

36. The device of claim 33, wherein using the structured mapping further comprises:
mapping based on a position of the current transform coefficient.

37. The device of claim 33, wherein using the structured mapping further comprises:
mapping based on at least one value stored in a memory associated with the VLC decoding module.

38. The device of claim 37, wherein using the structured mapping further comprises:
determining the at least one value stored in the memory based on a most likely run value from the current coefficient to a next non-zero coefficient of the block of video data with a magnitude greater than one.

39. The device of claim 37, further comprising:
determining the at least one value stored in memory based on a noTr1 value for a currently coded transform coefficient, wherein the noTr1 value indicates whether at least one other previously coded transform coefficient of the block has a magnitude greater than one.

40. The device of claim 37, further comprising:
determining the at least one value stored in memory based on accessing at least one table stored in the memory that defines the at least one value.

41. The device of claim 37, wherein the at least one value stored in memory comprises an lrg1Pos value.

42. The device of claim 33, wherein mapping based on the structured mapping comprises:
mapping without using a mapping table stored in memory that defines the relationship between the code number cn and the level_ID value and the run value.

43. A device for encoding a block of video data, comprising:
means for determining a level_ID value and a run value associated with a transform coefficient of the block of video data
means for determining a code number cn based on the determined level_ID value and the determined run value using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data;
means for determining a VLC codeword based on the determined code number cn; and
means for outputting the determined VLC codeword.

44. A computer-readable storage medium that stores instructions configured to cause a computing device to:
determine a level_ID value and a run value associated with a transform coefficient of the block of video data
determine a code number cn based on the determined level_ID value and the determined run value using a structured mapping that defines a relationship between the code number cn and the level_ID value and the run value, wherein the level_ID value indicates, with respect to a position of a current transform coefficient, whether a next non-zero transform coefficient of a block of video data has a magnitude of one or greater than one, and wherein the run value indicates a number of zero value transform coefficients of the block, from the current transform coefficient to the next non-zero transform coefficient of the block of video data;
determine a VLC codeword based on the determined code number cn; and
output the determined VLC codeword.

45. A method of decoding a current transform coefficient of a block of video data, comprising:
determining a coded block type of a block of video data that includes at least one transform coefficient;
determining a code number cn based on a VLC codeword;
if the block of video data has a first coded block type, determining a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block has a second coded block type different than the first coded block type, determining the level_ID value and the run value associated with the transform coefficient using a second technique different than the first technique; and
using the determined level_ID value and the determined run value to decode the block of video data.

46. The method of claim 45, wherein using the first technique comprises mapping based on a structured mapping; and
wherein using the second technique comprises mapping based on at least one mapping table stored in a memory.

47. The method of claim 46, wherein the structured mapping comprises mapping based on a mathematical relationship.

48. The method of claim 46, wherein mapping based on the structured mapping comprises mapping based on a most likely run value from the current coefficient to a next non-zero coefficient of the block of video data with a magnitude greater than one.

49. The method of claim 48, further comprising:
mapping based on at least one value stored in memory.

50. The method of claim 49, wherein the at least one value stored in memory indicates a most likely run value from the current coefficient to a next non-zero coefficient of the block of video data with a magnitude greater than one.

51. The method of claim 49, further comprising:
determining the at least one value stored in memory based on a noTr1 value that indicates whether at least one previously decoded transform coefficient of the block has a magnitude greater than one or a number of other previously decoded transform coefficients have a value substantially equal to one.

52. The method of claim 49, further comprising:
determining the at least one value stored in memory based on at least one table stored in the memory that defines the at least one value.

53. The method of claim 46, wherein the mapping based on the second technique comprises:
selecting the mapping table stored in the memory from a plurality of mapping tables stored in the memory.

54. The method of claim 53, wherein selecting the mapping table comprises selecting from a plurality of mapping tables each dedicated to potential positions for transform coefficients of the block of video data.

55. The method of claim 46, wherein mapping based on the first technique comprises mapping without accessing the least one mapping table stored in the memory.

56. The method of claim 45, wherein mapping based on the first technique uses less memory than mapping based on the second technique.

57. A device configured to decode a block of video data, comprising:
a VLC decoding module configured to:
determine a coded block type of a block of video data that includes at least one transform coefficient;
determine a code number cn based on a VLC codeword;
if the block of video data has a first coded block type, determine a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block has a second coded block type different than the first coded block type, determining the level_ID value and the run value associated with the transform coefficient using a second technique different than the first technique; and
use the determined level_ID value and the determined run value to decode the block of video data.

58. A computer-readable storage medium comprising instructions configured to cause a computing device to:
determine a coded block type of a block of video data that includes at least one transform coefficient;
determine a code number cn based on a VLC codeword;
if the block of video data has a first coded block type, determine a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block has a second coded block type different than the first coded block type, determine the level_ID value and the run value associated with the transform coefficient using a second technique different than the first technique; and
use the determined level_ID value and the determined run value to decode the block of video data.

59. A method of encoding a current transform coefficient of a block of video data, comprising:
determining a coded block type of a block of video data that includes at least one transform coefficient;
determining a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block of video data has a first coded block type, determining a code number cn based on the determined level_ID value and the determined run value using a first technique;
if the block has a second coded block type different than the first coded block type, determining the code number cn based on the determined level_ID value and the determined run value using a second technique different than the first technique;
determining a VLC codeword based on the determined code number cn; and
outputting the determined VLC codeword.

60. The method of claim 59, wherein using the first technique comprises mapping based on a structured mapping; and
wherein using the second technique comprises mapping based on at least one mapping table stored in a memory.

61. The method of claim 60, wherein the structured mapping comprises mapping based on a mathematical relationship.

62. The method of claim 60, wherein mapping based on the structured mapping comprises mapping based on a most likely run value from the current coefficient to a next non-zero coefficient of the block of video data with a magnitude greater than one.

63. The method of claim 62, further comprising:
mapping based on at least one value stored in memory.

64. The method of claim 63, wherein the at least one value stored in memory indicates a most likely run value from the current coefficient to a next non-zero coefficient of the block of video data with a magnitude greater than one.

65. The method of claim 63, further comprising:
determining the at least one value stored in memory based on a noTr1 value that indicates whether at least one previously decoded transform coefficient of the block has a magnitude greater than one or a number of other previously decoded transform coefficients have a value substantially equal to one.

66. The method of claim 63, further comprising:
determining the at least one value stored in memory based on at least one table stored in the memory that defines the at least one value.

67. The method of claim 60, wherein the mapping based on the second technique comprises:
selecting the mapping table stored in the memory from a plurality of mapping tables stored in the memory.

68. The method of claim 67, wherein selecting the mapping table comprises selecting from a plurality of mapping tables each dedicated to potential positions for transform coefficients of the block of video data.

69. The method of claim 60, wherein mapping based on the first technique comprises mapping without accessing the least one mapping table stored in the memory.

70. The method of claim 59, wherein mapping based on the first technique uses less memory than mapping based on the second technique.

71. A device configured to encode a block of video data, comprising:
a VLC encoding module configured to:
determine a coded block type of a block of video data that includes at least one transform coefficient;
determine a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block of video data has a first coded block type, determine a code number cn based on the determined level_ID value and the determined run value using a first technique;
if the block has a second coded block type different than the first coded block type, determine the code number cn based on the determined level_ID value and the determined run value using a second technique different than the first technique;
determine a VLC codeword based on the determined code number cn; and
output the determined VLC codeword.

72. A computer-readable storage medium comprising instructions configured to cause a computing device to:
determine a coded block type of a block of video data that includes at least one transform coefficient;
determine a level_ID value and a run value associated with the at least one transform coefficient using a first technique, wherein the level_ID value indicates, with respect to a position of a current transform coefficient of the block of video data, whether a next non-zero transform coefficient of the block of video data has a magnitude of one or greater than one, wherein the run value indicates a number of zero value transform coefficients of the block, from the current transform coefficient to the next non-zero transform coefficient of the block of video data, and wherein the code number cn comprises an codeword index value for a VLC table selected from one or more VLC tables;
if the block of video data has a first coded block type, determine a code number cn based on the determined level_ID value and the determined run value using a first technique;
if the block has a second coded block type different than the first coded block type, determine the code number cn based on the determined level_ID value and the determined run value using a second technique different than the first technique;
determine a VLC codeword based on the determined code number cn; and
output the determined VLC codeword.
